(19) United States
(12) Patent Application Publication
(10) Pub. No.: US 2017/0320972 A1
(43) Pub. Date: Nov. 9, 2017

(54) CATALYSTS

(71) Applicant: SCG CHEMICALS CO., LTD., Bangsue Bangkok (TH)

(72) Inventors: Dermot O'HARE, Oxford (GB); Jean-Charles BUFFET, Oxford (GB); Tossapol KHAMNAEN, Bangsue Bangkok (TH); Thomas ARNOLD, Oxford (GB)

(21) Appl. No.: 15/526,174

(22) PCT Filed: Nov. 13, 2015
(86) PCT No.: PCT/GB2015/053459

§ 371 Date: May 11, 2017

(30) Foreign Application Priority Data
Nov. 13, 2014 (GB) 1420215.4

(51) Int. Cl. C08F 4/6592; C08F 110/02; C08F 4/659

(52) U.S. Cl. CPC C08F 4/65927; C08F 4/65912; C08F 110/02

(57) ABSTRACT

Novel catalytic compositions are disclosed comprising symmetrical metallocene catalytic compounds. Also disclosed are uses of such catalytic compositions in olefin polymerisation reactions, as well as processes for polymerising olefins. When compared with prior art compositions, the catalytic compositions of the invention are markedly more active in the polymerisation of olefins.

### INTRODUCTION

The present invention relates to catalysts. More specifically, the present invention relates to particular metallocene catalysts and the use of such catalysts in polyolefin polymerization reactions. Even more specifically, the present invention relates to symmetrical metallocene catalysts, and the use of such catalysts in ethylene polymerization reactions.

### BACKGROUND OF THE INVENTION

It is well known that ethylene (and α-olefins in general) can be readily polymerized at low or medium pressures in the presence of certain transition metal catalysts. These catalysts are generally known as Zeigler-Natta type catalysts.

A particular group of these Ziegler-Natta type catalysts, which catalyse the polymerization of ethylene (and α-olefins in general), comprise an aluminoxane activator and a metallocene transition metal catalyst. Metallocenes comprise a metal bound between two η⁵-cyclopentadienyl type ligands. Generally the η⁵-cyclopentadienyl type ligands are selected from η⁵-cyclopentadienyl, η⁵-indenyl and η⁵-fluorenyl.

It is also well known that these η⁵-cyclopentadienyl type ligands can be modified in a myriad of ways. One particular modification involves the introduction of a linking group between the two cyclopentadienyl rings to form ansa-metallocenes.

Numerous ansa-metallocenes of transition metals are known in the art. However, there remains a need for improved ansa-metallocene catalysts for use in polyolefin polymerization reactions. In particular, there remains a need for new metallocene catalysts with high polymerization activities/efficiencies.

There is also a need for catalysts that can produce polyethylenes with particular characteristics. For example, catalysts capable of producing linear high density polyethylene (LHDPE) with a relatively narrow dispersion in polymer chain length are desirable. Moreover, there is a need for catalysts that can produce polyethylene copolymers having good co-monomer incorporation and good intermolecular uniformity of polymer properties.

WO2011/051705 discloses ansa-metallocene catalysts based on two η⁵-indenyl ligands linked via an ethylene group, which is supported on methyl aluminoxane (MAO)-supported silica and used in ethylene polymerization.

There remains a need for metallocene catalysts having improved polymerization activity. Moreover, due to the high value that industry places on such materials, there is also a need for metallocene catalysts capable of polymerizing α-olefins to high molecular weights, without compromising polydispersity. It is even further desirable that such catalysts can be easily synthesized.

The present invention was devised with the foregoing in mind.

### SUMMARY OF THE INVENTION

According to a first aspect of the present invention there is provided a composition comprising a solid methyl aluminoxane support material and a compound of formula (I) defined herein.

According to a second aspect of the present invention, there is provided a use of a composition as defined herein as a polymerisation catalyst for the polymerisation of a polyethylene homopolymer or a copolymer comprising polyethylene.

According to a third aspect of the present invention, there is provided a process for forming a polyethylene homopolymer or a polyethylene copolymer which comprises reacting olefin monomers in the presence of a composition as defined herein.

### DETAILED DESCRIPTION OF THE INVENTION

### Definitions

The term “alkyl” as used herein includes reference to a straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tertbutyl), pentyl, hexyl and the like. In particular, an alkyl may have 1, 2, 3, 4 or 5 carbon atoms.

The term “alkenyl” as used herein include reference to straight or branched chain alkenyl moieties, typically having 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein include reference to straight or branched chain alkynyl moieties, typically having 2, 3, 4, 5 or 6 carbon atoms. The term includes reference to alkynyl moieties containing 1, 2 or 3 carbon-carbon triple bonds (C≡C). This term includes reference to groups such as ethynyl, propynyl, butynyl, pentynyl and hexynyl.

The term “alkoxy” as used herein include reference to —O-alkyl, wherein alkyl is straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” as used herein includes reference to an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “halogen” or “halo” as used herein includes reference to F, Cl, Br or I. In a particular, halogen may be Br or Cl, of which Cl is more common.

The term “substituted” as used herein in reference to a moiety means that one or more, especially up to 5, more especially 1, 2 or 3, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible. For example, amino or hydroxy groups with free hydrogen may be unstable if bound to carbon atoms with unsaturated (e.g. olefinic) bonds. Additionally, it will of course be understood that the substituents described herein may themselves be substituted by any substituent, subject to the aforementioned restriction to appropriate substitutions as recognised by the skilled person.

### Catalytic Compositions

As discussed hereinbefore, the present invention provides a composition comprising a solid methyl aluminoxane support material and a compound of the formula (I) shown below:

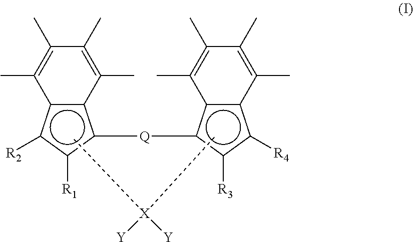

wherein:

R₁, R₂, R₃ and R₄ are each independently (1-3C)alkyl;

Q is absent, or is a bridging group comprising 1, 2 or 3 bridging carbon atoms, and is optionally substituted with one or more groups selected from hydroxyl, (1-6C)alkyl, (2-6C)alkenyl, (2-6C)alkynyl, (1-6C)alkoxy, Si[(1-4C)alkyl]₃, aryl, and —C(O)NRₓR_{y};

X is selected from zirconium, titanium or hafnium; and

each Y group is independently selected from halo, hydride, a phosphonated, sulfonated or borate anion, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, (1-6C)alkoxy, Si[(1-4C)alkyl]₃ or —C(O)NRₓR_{y};

wherein Rₓ and R_{y} are independently (1-4C)alkyl.

It will be appreciated that the structural formula (I) presented above is intended to show the substituent groups in a clear manner. A more representative illustration of the spatial arrangement of the groups is shown in the alternative representation below:

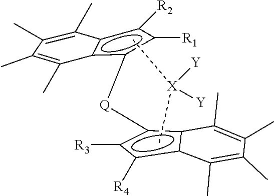

It will also be appreciated that the compounds forming part of the present invention may be present as meso or rac isomers (shown below), and the present invention includes both such isomeric forms. A person skilled in the art will appreciate that a mixture of isomers of the compound of formula (I) may be used for catalysis applications, or the isomers may be separated and used individually (using techniques well known in the art, such as, for example, fractional crystallization).

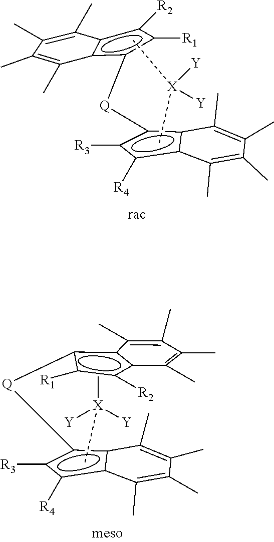

The compositions of the invention exhibit superior catalytic performance when compared with current metallocene compounds/compositions used in the polymerisation of α-olefins. In particular, when compared with analogous silica-supported methyl aluminoxane (SSMAO) (otherwise known as MAO-activated silica) and layered double hydroxide-supported methyl aluminoxane (LDHMAO) (otherwise known as MAO-activated layered double hydroxide) catalyst compositions, the solid MAO compositions of the invention exhibit significantly increased catalytic activity in the homopolymerisation and copolymerisation of α-olefins. Furthermore, polyethylene copolymers produced by α-olefin polymerization in the presence of compositions of the invention demonstrate good co-monomer incorporation in polyethylene, with good inter-molecular uniformity.

Solid methyl aluminoxane (MAO) (often referred to as polymethylaluminoxane) is distinguished from other methyl aluminoxanes (MAOs) as it is insoluble in hydrocarbon solvents and so acts as a heterogeneous support system. Any suitable solid MAO support may be used.

In an embodiment, the solid MAO support is insoluble in toluene and hexane.

In another embodiment, the solid MAO support is in particulate form. Suitably, the particles of the solid MAO support are spherical, or substantially spherical, in shape.

In a particularly suitable embodiment, the solid MAO support is as described in US2013/0059990 and obtainable from Tosoh Finechem Corporation, Japan.

In an embodiment, the solid MAO support is prepared according to the following protocol:

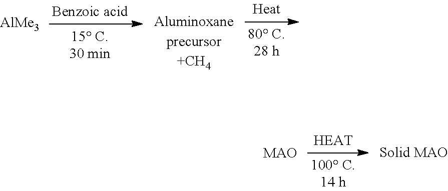

The properties of the solid MAO support can be adjusted by altering one or more of the processing variables used during its synthesis. For example, in the above-outlined protocol, the properties of the solid MAO support may be adjusted by varying the Al:O ratio, by fixing the amount of AlMe₃ and varying the amount of benzoic acid. Exemplary Al:O ratios are 1:1, 1.1:1, 1.2:1, 1.3:1, 1.4:1 and 1.6:1. Suitably the Al:O ratio is 1.2:1 or 1.3:1. Alternatively, the properties of the solid MAO support may be adjusted by fixing the amount of benzoic acid and varying the amount of AlMe₃.

In another embodiment, the solid MAO support is prepared according to the following protocol:

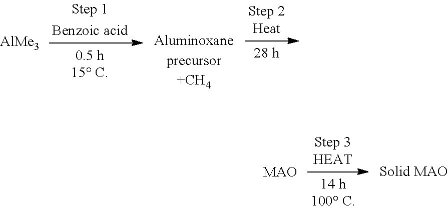

In the above protocol, steps 1 and 2 may be kept constant, with step 2 being varied. The temperature of step 2 may be 70-100° C. (e.g. 70° C., 80° C., 90° C. or 100° C.). The duration of step 2 may be from 12 to 28 hours (e.g. 12, 20 or 28 hours).

The compound of formula (I) may be immobilized on the solid MAO support by one or more ionic or covalent interactions.

In an embodiment, the composition further comprises one or more suitable activators. Suitable activators are well known in the art and include organo aluminium compounds (e.g. alkyl aluminium compounds). Particularly suitable activators include aluminoxanes (e.g. methylaluminoxane (MAO)), triisobutylaluminium (TIBA), diethylaluminium (DEAC) and triethylaluminium (TEA).

In another embodiment, the solid MAO support comprises additional compound selected from M(C₆F₅)₃, wherein M is aluminium or boron, or M′R₂, wherein M′ is zirconium or magnesium and R is (1-10C)alkyl (e.g. methyl or octyl).

In an embodiment,
R₁, R₂, R₃ and R₄ are each independently (1-3C)alkyl;
Q is absent, or is a bridging group comprising 1, 2 or 3 bridging carbon atoms, and is optionally substituted with one or more groups selected from hydroxyl, (1-6C)alkyl, (2-6C)alkenyl, (2-6C)alkynyl, (1-6C)alkoxy, Si[(1-4C)alkyl]₃, aryl, and —C(O)NRₓR_{y};
X is selected from zirconium, titanium or hafnium; and
each Y group is independently selected from halo, hydride, a phosphonated, sulfonated or borate anion, or a (1-6C)alkyl, (2-6C)alkenyl, (2-6C)alkynyl, (1-6C)alkoxy, aryl or aryloxy group which is optionally substituted with halo, nitro, amino, phenyl, (1-6C)alkoxy, Si[(1-4C)alkyl]₃ or —C(O)NRₓR_{y};
wherein Rₓ and R_{y} are independently (1-4C)alkyl.

In an embodiment, R₁, R₂, R₃ and R₄ are each independently (1-2C)alkyl. Suitably, R₁, R₂, R₃ and R₄ are all methyl.

In another embodiment, Q is absent, or is a bridging group having the formula —[C(Rₐ)(R_{b})—C(R_{c})(R_{d})]—, wherein Rₐ, R_{b}, R_{c} and R_{d} are independently selected from hydrogen, hydroxyl, (1-6C)alkyl, (2-6C)alkenyl, (2-6C)alkynyl, (1-6C)alkoxy and aryl.

In another embodiment, Q is absent, or is a bridging group having the formula —[C(Rₐ)(R_{b})—C(R_{c})(R_{d})]—, wherein Rₐ, R_{b}, R_{c} and R_{d} are independently selected from hydrogen, hydroxyl, (1-4C)alkyl, (2-4C)alkenyl, (2-4C)alkynyl, (1-4C)alkoxy and phenyl.

Suitably, Q is absent, or is a bridging group having the formula —[C(Rₐ)(R_{b})—C(R_{c})(R_{d})]—, wherein Rₐ, R_{b}, R_{c} and R_{d} are independently selected from hydrogen, hydroxyl, (1-4C)alkyl, (2-4C)alkenyl, (2-4C)alkynyl and phenyl.

In a particular embodiment, Q is a bridging group having the formula —CH₂CH₂—.

In a particular embodiment, Q is absent.

In another embodiment, each Y group is independently selected from halo, hydride, or a (1-6C)alkyl, (2-6C)alkenyl, (2-6C)alkynyl, (1-6C)alkoxy, aryl or aryloxy group which is optionally substituted with one or more groups selected from (1-6C)alkyl, halo, nitro, amino, phenyl, (1-6C)alkoxy, Si[(1-4C)alkyl]₃ or —C(O)NRₓR_{y};

wherein Rₓ and R_{y} are independently (1-4C)alkyl.

In another embodiment, each Y is independently selected from halo, —CH₂C(CH₃)₃ or a (1-2C)alkyl group which is optionally substituted with halo, phenyl, or Si[(1-4C)alkyl]₃. Suitably, each Y is halo.

In another embodiment, each Y is independently selected from halo, —CH₂C(CH₃)₃ or a (1-2C)alkyl group which is optionally substituted with halo or phenyl.

In another embodiment, each Y is independently selected from Cl, —CH₂C(CH₃)₃ or CH₂C₆H₅.

In another embodiment, each Y is independently selected from Cl or CH₂C₆H₅.

In another embodiment, X is zirconium or hafnium. Suitably, X is zirconium.

In another embodiment, the compound of formula (I) has the formula (II) shown below:

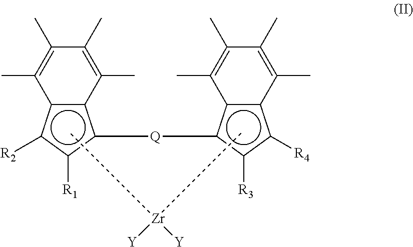

wherein:

R₁, R₂, R₃, R₄, Q and Y are each independently as defined in any of the paragraphs hereinbefore.

In another embodiment, the compound has the formula (II), wherein

R₁, R₂, R₃ and R₄ are each independently (1-2C)alkyl;
Q is absent, or is a bridging group having the formula —[C(Rₐ)(R_{b})—C(R_{c})(R_{d})]—, wherein Rₐ, R_{b}, R_{c} and R_{d} are independently selected from hydrogen, hydroxyl, (1-4C)alkyl, (2-4C)alkenyl, (2-4C)alkynyl and phenyl; and
each Y is independently selected from halo, —CH₂C(CH₃)₃ or a (1-2C)alkyl group which is optionally substituted with halo or phenyl.

In another embodiment, the compound has the formula (II), wherein

R₁, R₂, R₃ and R₄ are each independently (1-2C)alkyl;
Q is a bridging group having the formula —CH₂CH₂—; and
each Y is independently selected from halo, —CH₂C(CH₃)₃ or a (1-2C)alkyl group which is optionally substituted with halo or phenyl. Alternatively, each Y is independently selected from Cl, —CH₂C(CH₃)₃ or CH₂C₆H₅.

In another embodiment, the compound of formula (I) has the formula (III) shown below:

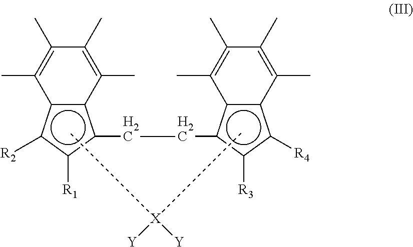

wherein
R₁, R₂, R₃, R₄, X and Y are each independently as defined in any of the paragraphs hereinbefore.

In another embodiment, the compound has the formula (III), wherein

R₁, R₂, R₃ and R₄ are each independently (1-2C)alkyl;
X is zirconium or hafnium; and
each Y is independently selected from halo, —CH₂C(CH₃)₃ or a (1-2C)alkyl group which is optionally substituted with halo or phenyl.

In another embodiment, the compound has the formula (III), wherein

R₁, R₂, R₃ and R₄ are each independently (1-2C)alkyl;
X is zirconium; and
each Y is independently selected from halo, —CH₂C(CH₃)₃ or a (1-2C)alkyl group which is optionally substituted with halo or phenyl. Alternatively, each Y is independently selected from Cl, —CH₂C(CH₃)₃ or CH₂C₆H₅.

In another embodiment, the compound of formula (I) has the formula (IV) shown below:

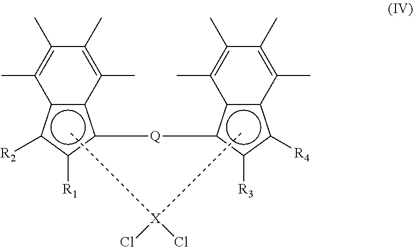

wherein

R₁, R₂, R₃, R₄, X and Q are each independently as defined in any of the paragraphs hereinbefore.

In another embodiment, the compound has the formula (IV), wherein

R₁, R₂, R₃ and R₄ are each independently (1-2C)alkyl;
X is zirconium or hafnium; and
Q is absent, or is a bridging group having the formula —[C(Rₐ)(R_{b})—C(R_{c})(R_{d})]—, wherein Rₐ, R_{b}, R_{c} and R_{d} are independently selected from hydrogen, hydroxyl, (1-4C)alkyl, (2-4C)alkenyl, (2-4C)alkynyl and phenyl.

In another embodiment, the compound has the formula (IV), wherein

R₁, R₂, R₃ and R₄ are each independently (1-2C)alkyl;
X is zirconium; and
Q is absent, or is a bridging group having the formula —CH₂CH₂—.

In another embodiment, the compound of formula (I) has the formula (V) shown below:

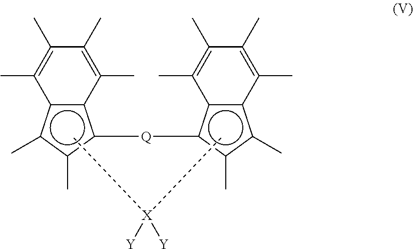

wherein

Y, X and Q are each independently as defined in any of the paragraphs hereinbefore.

In another embodiment, the compound has the formula (V), wherein

each Y is independently selected from halo, —CH₂C(CH₃)₃ or a (1-2C)alkyl group which is optionally substituted with halo or phenyl;
X is zirconium or hafnium; and
Q is absent, or is a bridging group having the formula —[C(Rₐ)(R_{b})—C(R_{c})(R_{d})]—, wherein Rₐ, R_{b}, R_{c} and R_{d} are independently selected from hydrogen, hydroxyl, (1-4C)alkyl, (2-4C)alkenyl, (2-4C)alkynyl and phenyl.
Alternatively, each Y is independently selected from Cl, —CH₂C(CH₃)₃ or CH₂C₆H₅.

In another embodiment, the compound has the formula (V), wherein

each Y is independently selected from Cl or CH₂C₆H₅;
X is zirconium; and
Q is absent, or is a bridging group having the formula —CH₂CH₂—.

In another embodiment, the compound of formula (I) has the formula (VI) shown below:

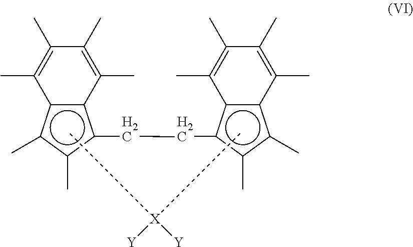

wherein

Y and X are each independently as defined in any of the paragraphs hereinbefore.

In another embodiment, the compound has the formula (VI), wherein each Y is independently selected from halo or a (1-2C)alkyl group which is optionally substituted with halo or phenyl; and

X is zirconium or hafnium.
Alternatively, each Y is independently selected from Cl, —CH₂C(CH₃)₃ or CH₂C₆H₅.

In another embodiment, the compound has the formula (VI), wherein

each Y is independently selected from Cl or CH₂C₆H₅; and
X is zirconium.

In another embodiment, the compound has the formula (VI), wherein

each Y is independently selected from Cl, —CH₂C(CH₃)₃ or CH₂C₆H₅; and
X is zirconium.

In another embodiment, the compound of formula (I) has any of the following structures:

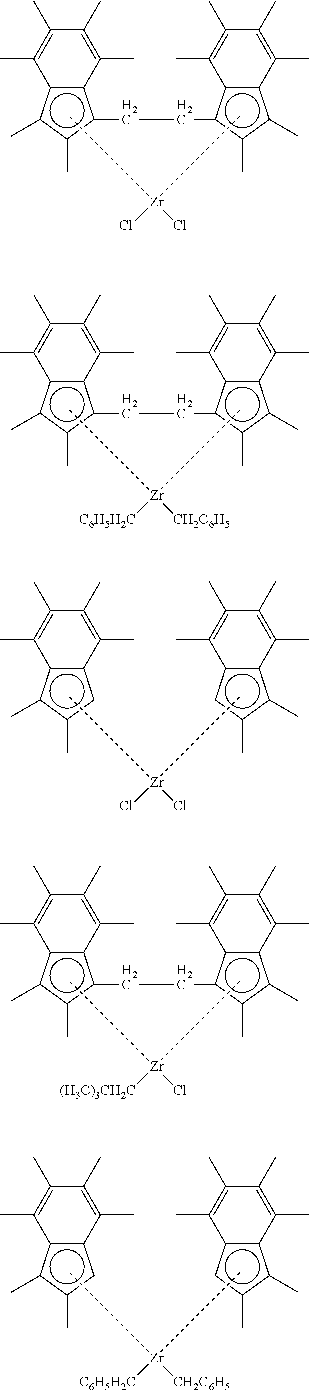

In another embodiment, the compound of formula (I) has any of the following structures:

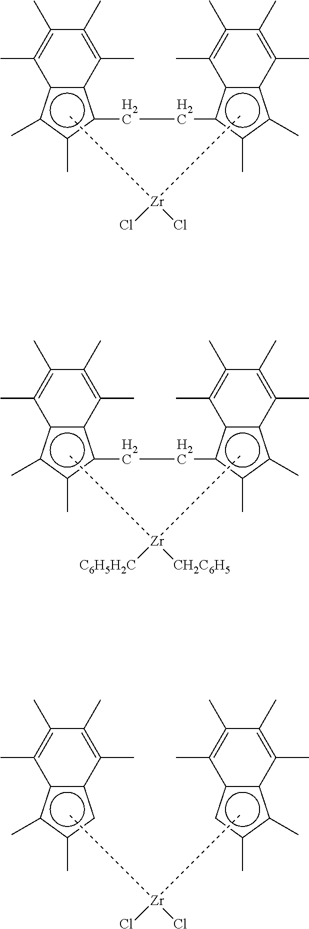

In another embodiment, the compound of formula (I) has the following structure:

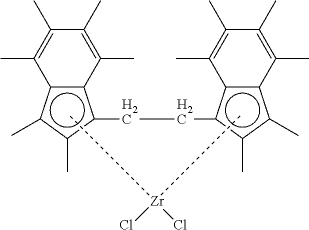

In another aspect, the present invention provides a compound of formula (I) as defined hereinbefore.

### Synthesis

The compounds forming part of the present invention may be synthesised by any suitable process known in the art. Particular examples of processes for the preparing compounds forming part of the present invention are set out in the accompanying examples.

Suitably, a compound of the present invention is prepared by:
(i) reacting a compound of formula A:

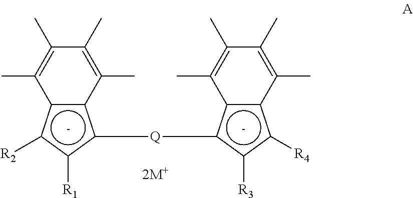

(wherein R₁, R₂, R₃, R₄ and Q are each as defined hereinbefore and M is Li, Na or K) with a compound of the formula B:

X(Y′)₄ B
(wherein X is as defined hereinbefore and Y′ is halo (particularly chloro or bromo)) in the presence of a suitable solvent to form a compound of formula (Ia):

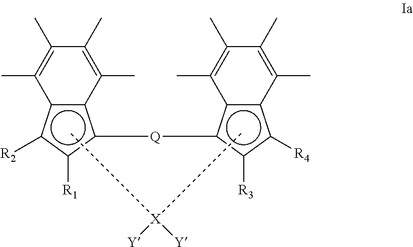

and optionally thereafter:
(ii) reacting the compound of formula Ia above with MY″ (wherein M is as defined above and Y″ is a group Y as defined herein other than halo), in the presence of a suitable solvent to form the compound of the formula (Ib) shown below

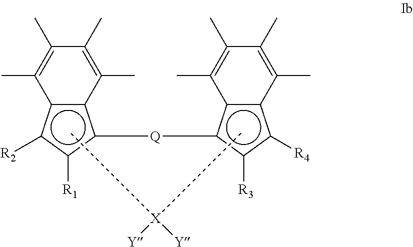

Suitably, M is Li in step (i) of the process defined above.

Suitably, the compound of formula B is provided as a solvate. In particular, the compound of formula B may be provided as X(Y′)₄.THFₚ, where p is an integer (e.g. 2).

Any suitable solvent may be used for step (i) of the process defined above. A particularly suitable solvent is toluene or THF.

If a compound of formula (I) in which Y is other than halo is required, then the compound of formula (Ia) above may be further reacted in the manner defined in step (ii) to provide a compound of formula (Ib).

Any suitable solvent may be used for step (ii) of the process defined above. A suitable solvent may be, for example, diethyl ether, toluene, THF, dicloromethane, chloroform, hexane, DMF, benzene etc.

Processes by which compounds of the formula A above can be prepared are well known in the art. For example, a process for the synthesis of a di-sodium ethylene-bis-hexamethylindenyl ligand is described in J. Organomet. Chem., 694, (2009), 1059-1068. A process for the synthesis of a di-lithium ethylene-bis-hexamethylindenyl ligand is described in the accompanying examples. The skilled person will appreciate that such methodology can be used to prepare other ligands falling within the scope of the present invention.

Compounds of formula A, in which Q is —CH₂—CH₂—, may generally be prepared by:

(i) Reacting a compound of formula D

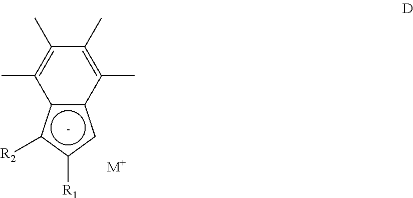

(wherein M is lithium, sodium, or potassium; and R₁ and R₂ are as defined hereinbefore) with an excess of BrCH₂CH₂Br to form a compound of the formula E shown below:

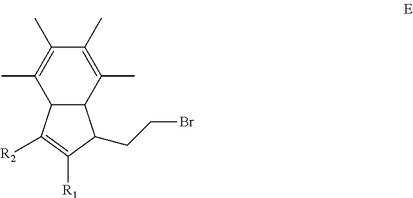

(wherein R₁ and R₂ are as defined hereinbefore); and

(ii) Reacting the compound of formula E with a compound of formula F shown below:

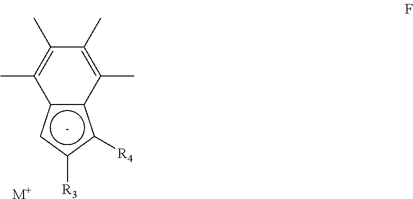

(wherein R₃ and R₄ are as defined hereinbefore, and M is lithium, sodium or potassium)

Compounds of formulae D and F can be readily synthesized by techniques well known in the art.

Any suitable solvent may be used for step (i) of the above process. A particularly suitable solvent is THF.

Similarly, any suitable solvent may be used for step (ii) of the above process. A suitable solvent may be, for example, toluene, THF, DMF etc.

A person of skill in the art will be able to select suitable reaction conditions (e.g. temperature, pressures, reaction times, agitation etc.) for such a synthesis.

### Applications

As previously indicated, the compositions of the present invention are extremely effective as catalysts in polyethylene homopolymerization and copolymerisation reactions.

As discussed hereinbefore, the compositions of the invention exhibit superior catalytic performance when compared with current metallocene compounds used in the polymerisation of α-olefins. In particular, when compared with analogous silica-supported methyl aluminoxane (SSMAO) and layered double hydroxide-supported methyl aluminoxane (LDHMAO) catalyst compositions, the solid MAO compositions of the invention exhibit significantly increased catalytic activity in the homopolymerisation and copolymerisation of α-olefins. Furthermore, polyethylene copolymers produced by α-olefin polymerization in the presence of compositions of the invention demonstrate good co-monomer incorporation in polyethylene, with good inter-molecular uniformity.

Thus, as discussed hereinbefore, the present invention also provides the use of a composition defined herein as a polymerization catalyst, in particular a polyethylene polymerization catalyst.

In one embodiment, the polyethylene is a homopolymer made from polymerized ethene monomers.

In another embodiment, the polyethylene is a copolymer made from polymerized ethene monomers comprising 1-10 wt % of (4-8C) α-olefin (by total weight of the monomers). Suitably, the (4-8C) α-olefin is 1-butene, 1-hexene, 1-octene, or a mixture thereof.

As discussed hereinbefore, the present invention also provides a process for forming a polyolefin (e.g. a polyethylene) which comprises reacting olefin monomers in the presence of a composition defined herein.

In another embodiment, the olefin monomers are ethene monomers.

In another embodiment, the olefin monomers are ethene monomers comprising 1-10 wt % of (4-8C) α-olefin (by total weight of the monomers). Suitably, the (4-8C) α-olefin is 1-butene, 1-hexene, 1-octene, or a mixture thereof.

In another embodiment, the process for forming a polyolefin is conducted at a temperature of 25-100° C. Suitably, the process for forming a polyolefin is conducted at a temperature of 70-80° C.

In another embodiment, the process for forming a polyolefin is conducted at a temperature of 40-70° C. Suitably, the process for forming a polyolefin is conducted at a temperature of 45-65° C. Alternatively, the process for forming a polyolefin is conducted at a temperature of 75-85° C.

A person skilled in the art of olefin polymerization will be able to select suitable reaction conditions (e.g. pressures, reaction times, solvents etc.) for such a polymerization reaction. A person skilled in the art will also be able to manipulate the process parameters in order to produce a polyolefin having particular properties.

In a particular embodiment, the polyolefin is polyethylene.

### EXAMPLES

Examples of the invention will now be described, for the purpose of reference and illustration only, with reference to the accompanying figures, in which:

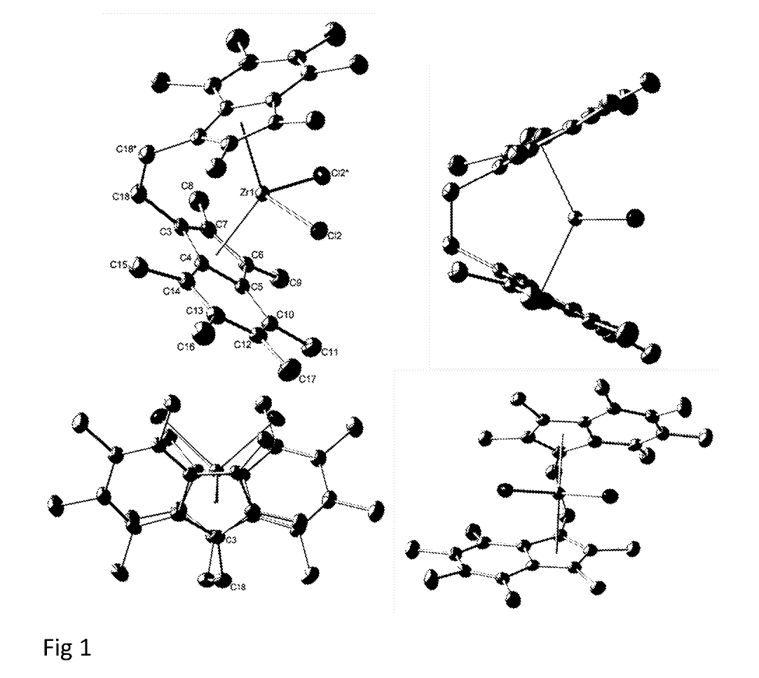

FIG. 1 shows four X-ray crystallographic views of rac-EBI*ZrCl₂ with H atoms omitted for clarity and thermal ellipsoids drawn at 50%.

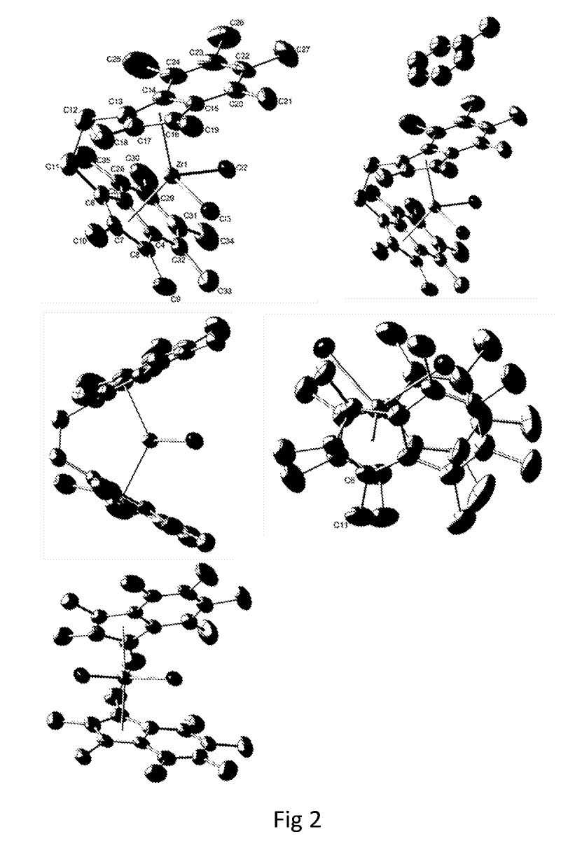

FIG. 2 shows alternate X-ray crystallographic views of meso-EBI*ZrCl₂ with H atoms and toluene omitted for clarity and thermal ellipsoids drawn at 50%; second view shows the location of the toluene molecule.

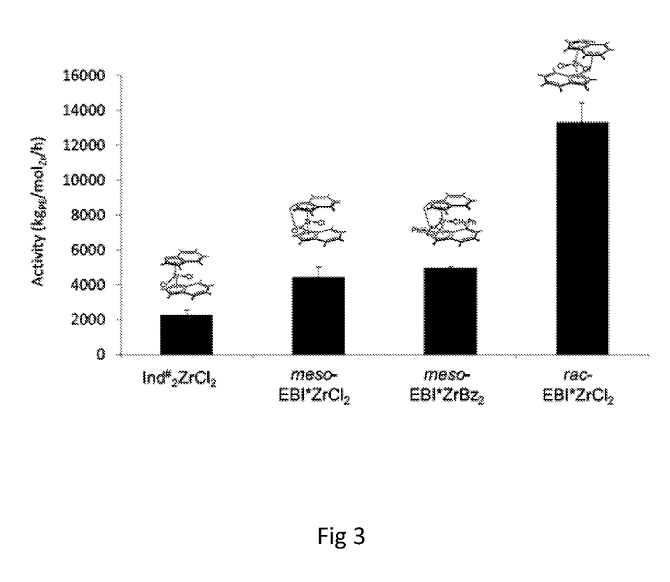

FIG. 3 shows ethylene polymerisation activity of rac-[(EBI*)ZrCl₂], meso-[(EBI*)ZrCl₂], meso[(EBI*)ZrBz₂] and [(Ind^{#})₂ZrCl₂] metallocenes supported on Tosoh Finechem solid MAO. Polymerisation conditions: 2 bar ethylene, 30 minutes, 50 ml hexane, 10 mg catalyst, 150 mg TIBA, 300:1 Al:Zr support loading on solid MAO.

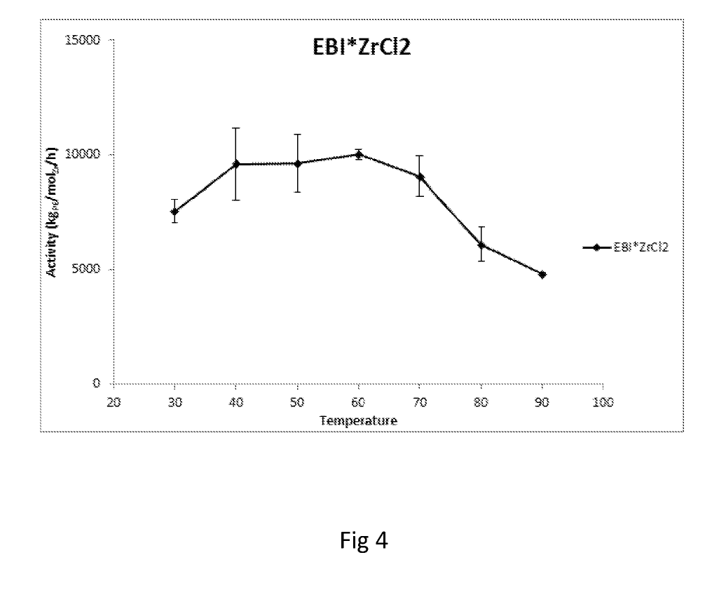

FIG. 4 shows ethylene polymerisation activity with varying temperature for [[rac-(EBI*)ZrCl₂] metallocene supported on Tosoh Finechem solid MAO. Polymerisation conditions: 2 bar ethylene, 30 minutes, 50 ml hexane, 10 mg catalyst, 150 mg TIBA, 200:1 Al:Zr support loading on Tosoh Finechem solid MAO.

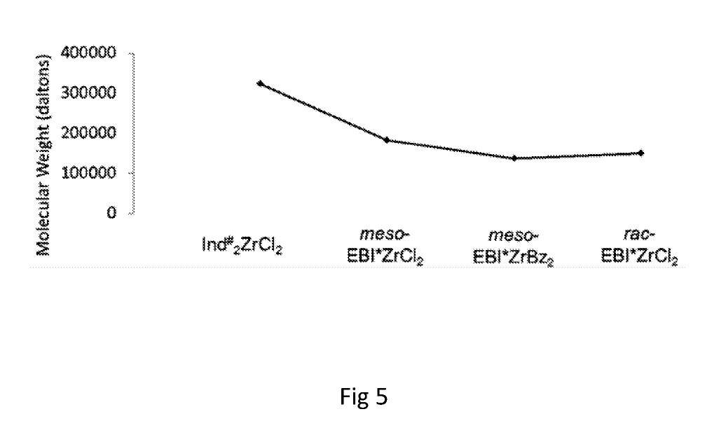

FIG. 5 shows a comparison of the molecular weight of polyethylene produced by polymerisation reactions using rac-[(EBI*)ZrCl₂], meso-[(EBI*)ZrCl₂], meso-[(EBI*)ZrBz₂] and [(Ind^{#})₂ZrCl₂] metallocenes supported on Tosoh Finechem solid MAO. Polymerisation conditions: 2 bar ethylene, 30 minutes, 50 ml hexane, 10 mg catalyst, 150 mg TIBA, 300:1 Al:Zr support loading on solid MAO.

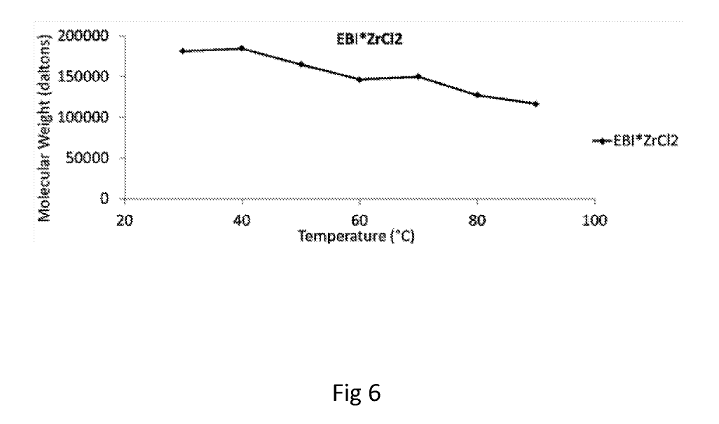

FIG. 6 shows the variation in the molecular weight of polyethylene produced by polymerisation reaction at various temperatures using [[rac-(EBI*)ZrCl₂] metallocene supported on Tosoh Finechem solid MAO. Polymerisation conditions: 2 bar ethylene, 30 minutes, 50 ml hexane, 10 mg catalyst, 150 mg TIBA, 200:1 Al:Zr support loading on Tosoh Finechem solid MAO.

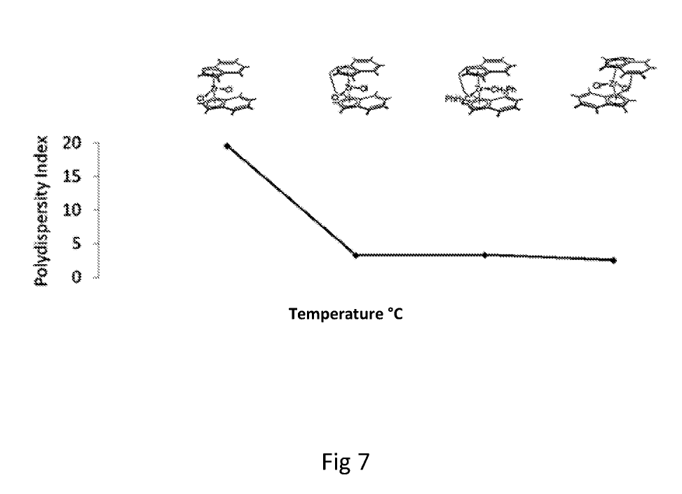

FIG. 7 shows a comparison of the polydispersity index of polyethylene produced by polymerisation reactions using rac-[(EBI*)ZrCl₂], meso-[(EBI*)ZrCl₂], meso-[(EBI*)ZrBz₂] and [(Ind^{#})₂ZrCl₂] metallocenes supported on Tosoh Finechem solid MAO. Polymerisation conditions: 2 bar ethylene, 30 minutes, 50 ml hexane, 10 mg catalyst, 150 mg TIBA, 300:1 Al:Zr support loading on solid MAO.

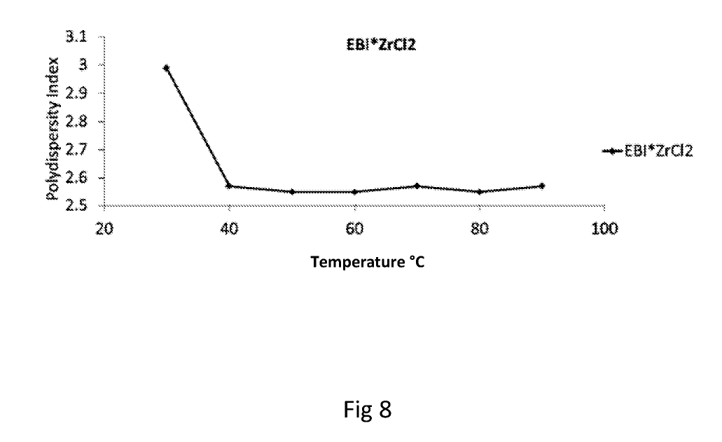

FIG. 8 shows the variation in the polydispersity of polyethylene produced by polymerisation reaction at various temperatures using [rac-(EBI*)ZrCl₂] metallocene supported on Tosoh Finechem solid MAO. Polymerisation conditions: 2 bar ethylene, 30 minutes, 50 ml hexane, 10 mg catalyst, 150 mg TIBA, 200:1 Al:Zr support loading on Tosoh Finechem solid MAO.

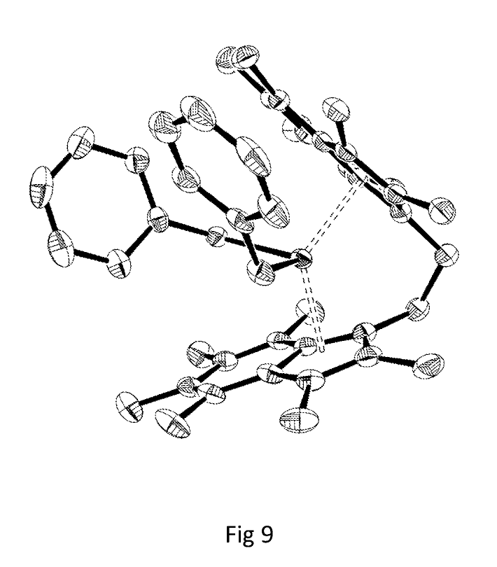

FIG. 9 shows X-ray crystallographic views of rac-EBI*ZrBz₂ with H atoms omitted for clarity and thermal ellipsoids drawn at 50%.

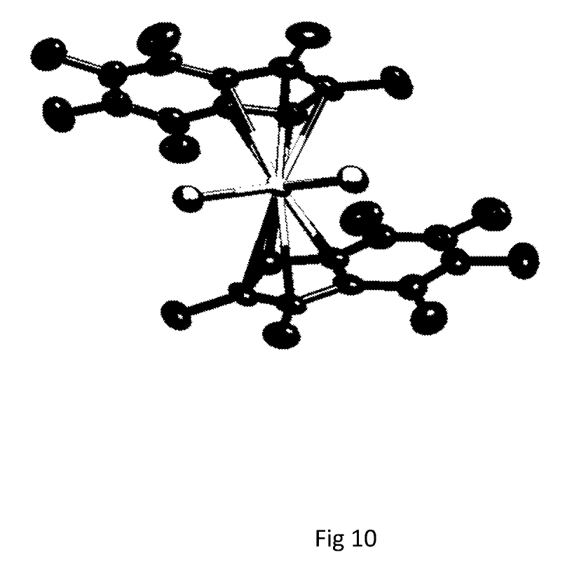

FIG. 10 shows X-ray crystallographic views of rac-Ind^{#}ZrCl₂ with H atoms omitted for clarity and thermal ellipsoids drawn at 50%.

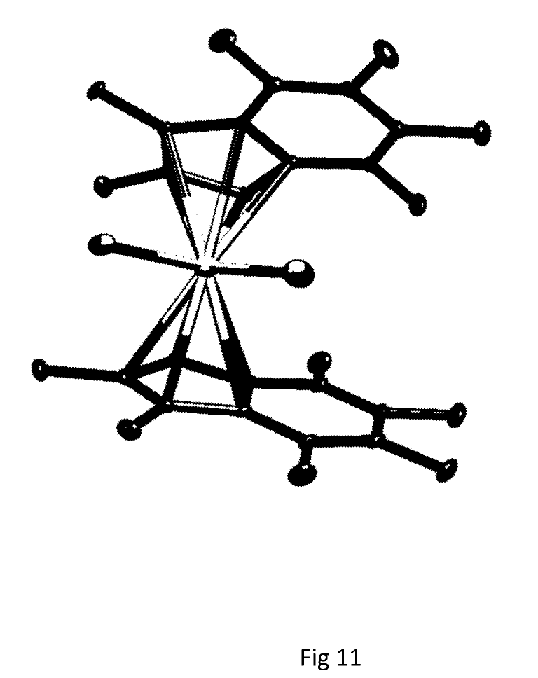

FIG. 11 shows X-ray crystallographic views of meso-Ind^{#}ZrCl₂ with H atoms omitted for clarity and thermal ellipsoids drawn at 50%.

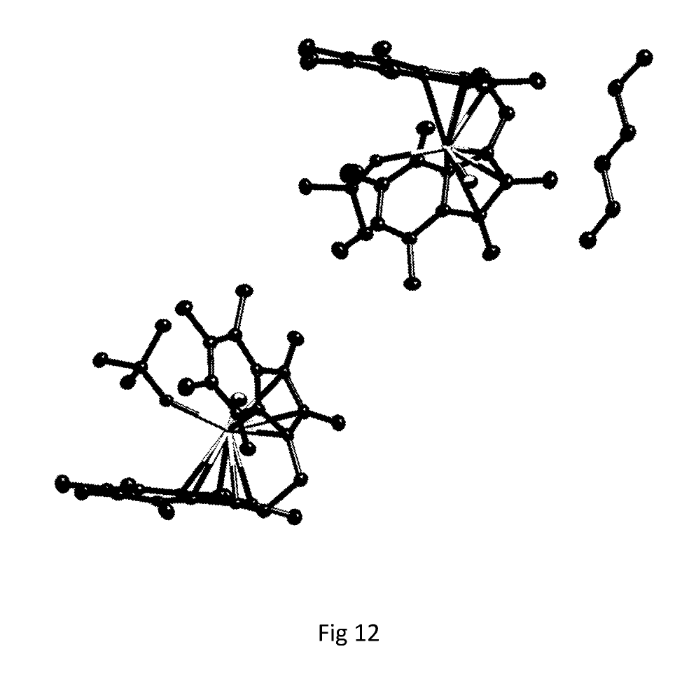

FIG. 12 shows X-ray crystallographic views of meso-(EBI*Zr(CH₂C(CH₃)₃)Cl) with H atoms omitted for clarity and thermal ellipsoids drawn at 50%.

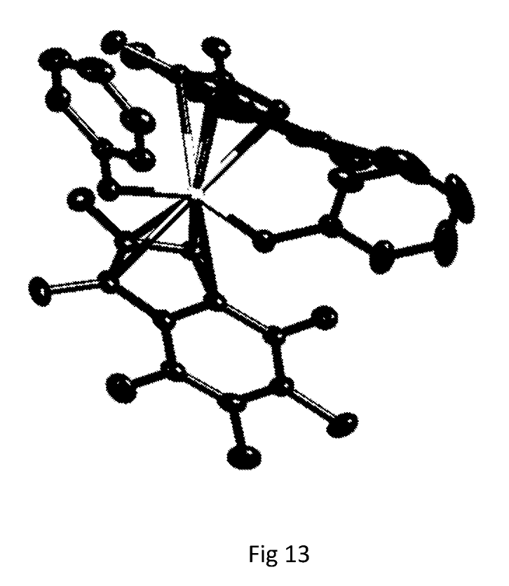

FIG. 13 shows X-ray crystallographic views of meso-Ind^{#}ZrBz₂ with H atoms omitted for clarity and thermal ellipsoids drawn at 50%.

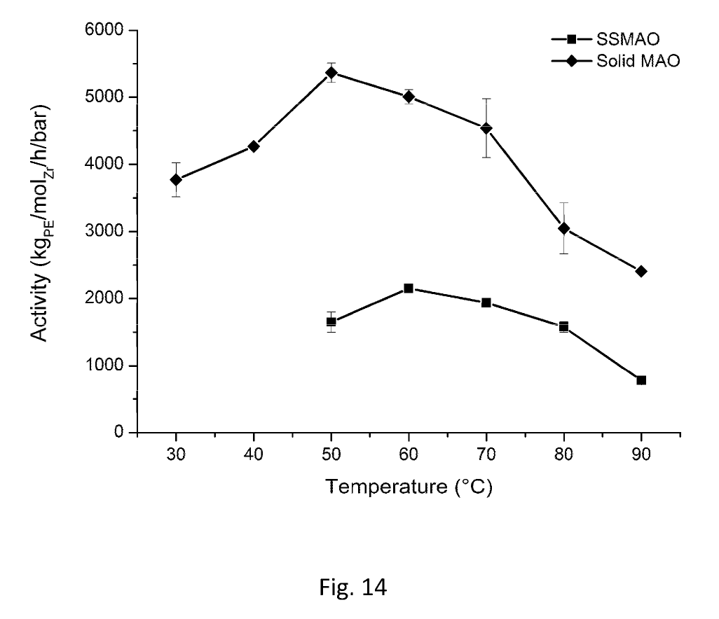

FIG. 14 shows the ethylene polymerisation activity dependence of rac-EBI*ZrCl₂ on temperature, supported on SSMAO (200:1, diamond) and Solid MAO (300:1, square). TIBA co-catalyst; 2 bar ethylene; 10 mg catalyst; 50 ml hexane; 1 hour (SSMAO), 30 minutes (Solid MAO).

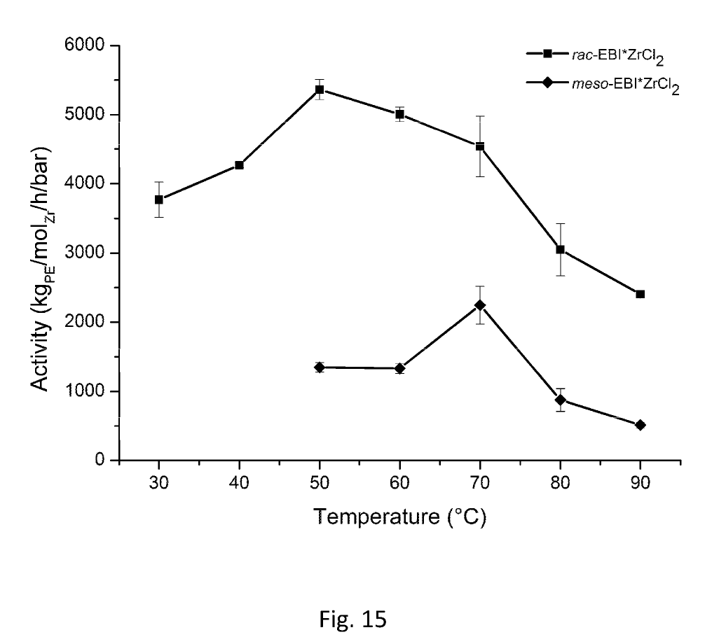

FIG. 15 shows the ethylene polymerisation activity dependence of rac-EBI*ZrCl₂ and meso-EBI*ZrCl₂ on temperature, supported on Solid MAO (200:1 rac-EBI*ZrCl₂, square; 300:1 meso-EBI*ZrCl₂, diamond); TIBA co-catalyst; 2 bar ethylene; 10 mg catalyst; 50 ml hexane; 1 hour (rac-EBI*ZrCl₂), 30 minutes (meso-EBI*ZrCl₂).

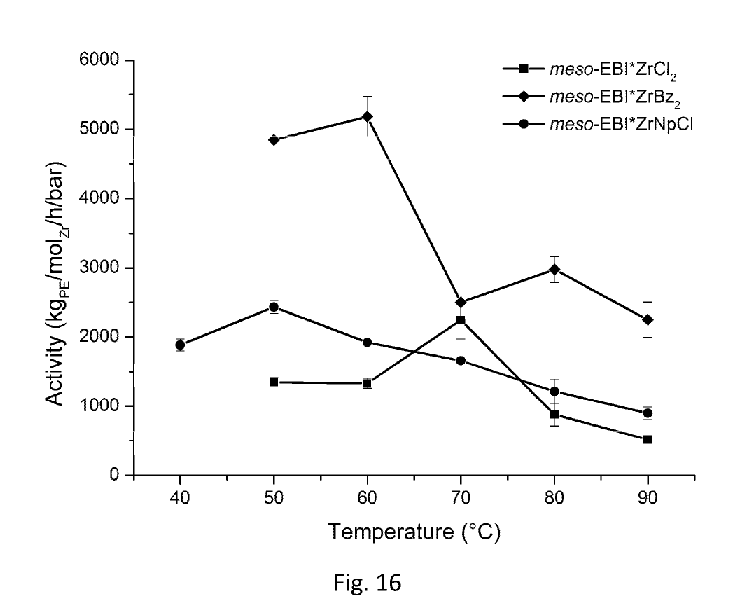

FIG. 16 shows the ethylene polymerisation activity dependence of meso-EBI*ZrCl₂ (square), meso-(EBI*)ZrBz₂ (diamond) and meso-(EBI*)ZrNpCl (circle) on temperature, supported on Solid MAO (300:1). TIBA co-catalyst; 2 bar ethylene; 10 mg catalyst; 50 ml hexane; 30 minutes.

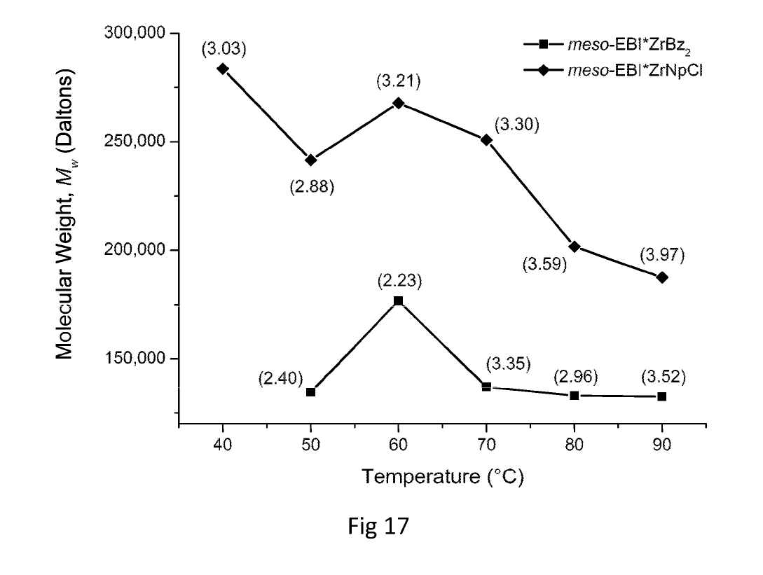

FIG. 17 shows the dependence of M_{w}, for meso-(EBI*)ZrBz₂ (square) and meso-(EBI*)ZrNpCl (diamond) on temperature. PDIs are given in parentheses. Supported on Solid MAO (300:1 loading); TIBA co-catalyst; 2 bar ethylene; 10 mg catalyst; 50 ml hexane; 30 minutes.

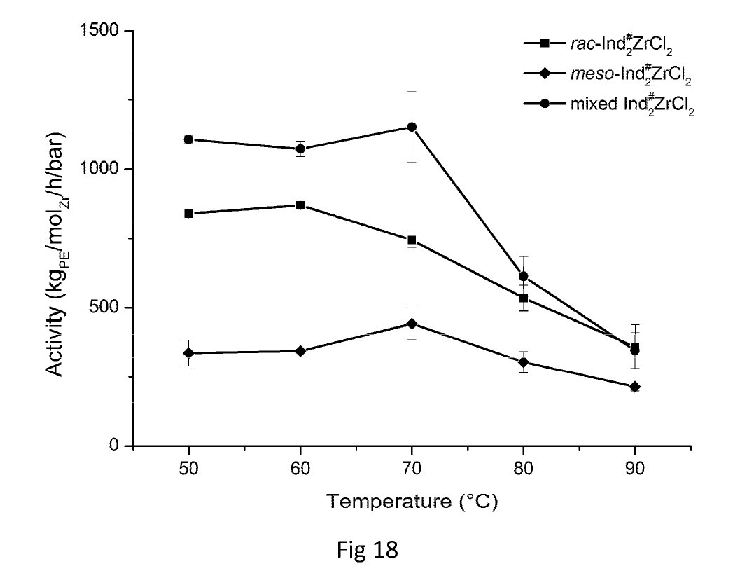

FIG. 18 shows the ethylene polymerisation activity dependence of rac- (square), meso-(diamond) and mixed-Ind₂^{#}ZrCl₂ (circle) on temperature. Supported on Solid MAO (300:1); TIBA co-catalyst; 2 bar ethylene; 10 mg catalyst; 50 ml hexane; 30 minutes.

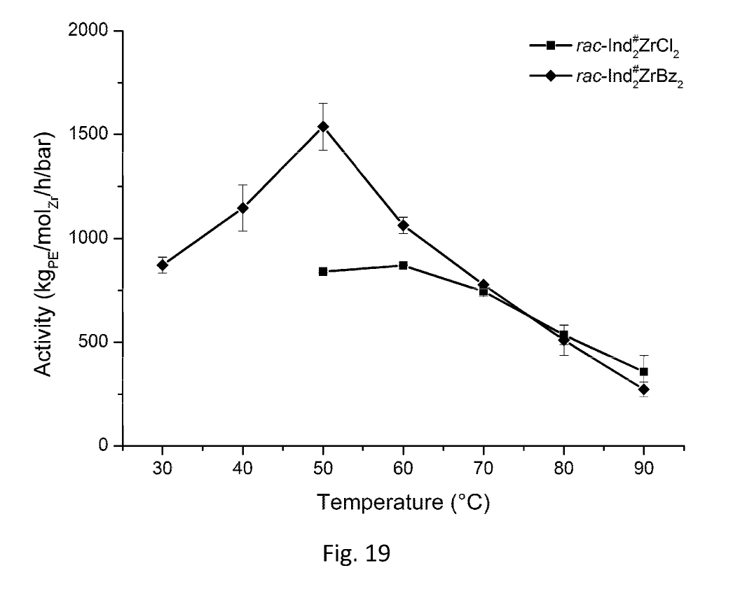

FIG. 19 shows the ethylene polymerisation activity dependence of rac-Ind₂^{#}ZrCl₂ (square) and rac-Ind₂^{#}ZrBz₂ (diamond) on temperature. Supported on Solid MAO (300:1); TIBA co-catalyst; 2 bar ethylene; 10 mg catalyst; 50 ml hexane; 30 minutes

### NOMENCLATURE

The nomenclature used herein will be readily understood by the skilled person having regard to the relevant structural formulae. Various abbreviations used throughout are expanded below:

EB means ethylene-bridged
I* means η⁵-2,3,4,5,6,7-hexamethyl-inden-1-yl (C₉Me₆)
Ind^{#} means η⁵-2,3,4,5,6,7-hexamethyl-1H-inden-1-yl (C₉Me₆H)
Ind* means η⁵-1,2,3,4,5,6,7-heptamethyl-inden-1-yl (C₉Me₆H)
Me means methyl
Bz means benzyl
Ph means phenyl
Np means neopentyl (CH₂C(CH₃)₃)

### General Methodology

All organometallic manipulations were performed under an atmosphere of N₂ using standard Schlenk line techniques or a MBraun UNllab glovebox, unless stated otherwise. All organic reactions were carried out under air unless stated otherwise. Solvents used were dried by either reflux over sodium-benzophenone diketyl (THF), or passage through activated alumina (hexane, Et₂O, toluene, CH₂Cl₂) using a MBraun SPS-800 solvent system. Solvents were stored in dried glass ampoules, and thoroughly degassed by passage of a stream of N₂ gas through the liquid and tested with a standard sodium-benzophenone-THF solution before use. Deuterated solvents for NMR spectroscopy of oxygen or moisture sensitive materials were treated as follows: C₆D₆ was freeze-pump-thaw degassed and dried over a K mirror; d⁵-pyridine and CDCl₃ were dried by reflux over calcium hydride and purified by trap-to-trap distillation; and CD₂Cl₂ was dried over 3 Å molecular sieves.

¹H and ¹³C NMR spectroscopy were performed using a Varian 300 MHz spectrometer and recorded at 300 K unless stated otherwise. ¹H and ¹³C NMR spectra were referenced via the residual protio solvent peak. Oxygen or moisture sensitive samples were prepared using dried and degassed solvents under an inert atmosphere in a glovebox, and were sealed in Wilmad 5 mm 505-PS-7 tubes fitted with Young's type concentric stopcocks.

Mass spectra were using a Bruker FT-ICR-MS Apex III spectrometer.

For Single-crystal X-ray diffraction in each case, a typical crystal was mounted on a glass fibre using the oil drop technique, with perfluoropolyether oil and cooled rapidly to 150 K in a stream of N₂ using an Oxford Cryosystems Cryostream.¹ Diffraction data were measured using an Enraf-Nonius KappaCCD diffractometer (graphite-monochromated MoKα radiation, λ=0.71073 Å). Series of ω-scans were generally performed to provide sufficient data in each case to a maximum resolution of 0.77 Å. Data collection and cell refinement were carried out using DENZO-SMN.² Intensity data were processed and corrected for absorption effects by the multi-scan method, based on multiple scans of identical and Laue equivalent reflections using SCALEPACK (within DENZO-SMN). Structure solution was carried out with charge flipping using the program Superflip³ within the CRYSTALS software suite.^{4,5} In general, coordinates and anisotropic displacement parameters of all non-hydrogen atoms were refined freely except where this was not possible due to the presence of disorder.

### Synthesis of Symmetrical Pro-Ligands

### Preparation of ethylene-bis-hexamethylindenyl, EBI*Li₂.THF_{0.38}:1

Li (0.13 g, 1.86×10⁻² mol) and naphthalene (2.56 g, 2.00×10⁻² mol) were stirred in THF, forming a green solution after 3 hours which still contained Li and so was stirred for a further 15 hours. C₁₆H₂₀ (3.69 g, 1.74×10⁻² mol) was dissolved in THF giving a bright yellow solution, which was added to the dark green C₁₀H₈Li mixture at −78° C. The reaction mixture was stirred at −78° C. for 30 minutes then allowed to warm to room temperature with stirring. A precipitate formed after 2 hours, and after a further 3 hours the solvent was removed under vacuum from the yellow-green mixture. The residue was washed with Et₂O and dried to yield an off white powder. Yield: 3.78 g, 93%. Analysis by NMR spectroscopy showed this solid to be of the formula EBI*Li₂.THF_{0.38}, ¹H NMR (d⁵-pyridine): δ 2.42, 2.45, 2.62, 2.89, 2.91 3.06 (all s, 6H, Me), 3.78 (s, 4H, C₂H₄). ¹³C NMR (d⁵-pyridine): δ 13.8, 16.3, 17.3, 17.4, 18.7, 19.2 (Me), 36.4 (C₂H₄), 97.8, 105.6, 119.1, 119.4, 123.5, 123.6, 124.8, 126.8, 128.8 (ring Cs).

### Preparation of disodium ethylene-bis-hexamethylindenyl (EBI*Na₂)

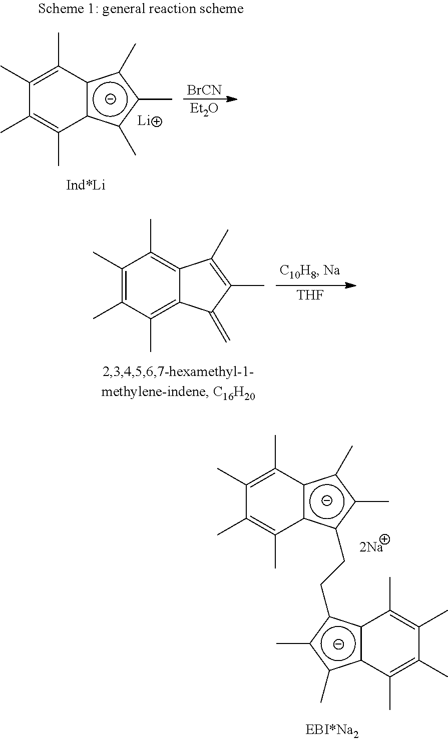

### (i) Synthesis of 2,3,4,5,6,7-hexamethyl-1-methylene-indene, C₁₆H₂₀

BrCN (2.89 g, 2.72×10⁻³ mol) was added under a N₂ flush to a −78° C. slurry in Et₂O of Ind*Li (6.00 g, 2.72×10⁻³ mol), prepared by a literature procedure.¹ The reaction mixture was stirred at −78° C. for 2 hours then allowed to warm to room temperature, upon which the off-white precipitate dissolved to give a yellow solution. After stirring for 15 hours under a dynamic pressure of N₂ to allow venting of HCN produced, volatiles were removed under vacuum. NMR analysis of the residues occasionally showed contamination of the desired product with an intermediate species, Ind*Br. Addition of Et₃N and further stirring converted this into the fulvene compound C₁₆H₂₀. Extraction with 30° C. pentane, passing the resulting solution through silica and removal of the solvent under vacuum afforded 2,3,4,5,6,7-hexamethyl-1-methylene-indene, C₁₆H₂₀ as a bright yellow solid. Yield: 4.10 g, 71%.

Characterising Data:

¹H NMR (C₆D₆) δ (ppm): 1.91, 2.08 (both s, 3H, Me), 2.11 (s, 6H, Me), 2.30, 2.36 (both s, 3H, Me), 5.56, 5.84 (both s, 1H, CH₂).

¹H NMR (CDC₃) δ (ppm): 2.00, 2.23, 2.26, 2.28 (all s, 3H, Me), 2.45 (bs, 6H, Me), 5.51, 5.88 (both s, 1H, CH₂).

¹³C NMR (C₆D₆) δ (ppm): 9.56, 15.53, 15.91, 16.03, 16.43, 16.64 (Me), 28.84 (CH₂), 126.35, 129.45, 131.49, 131.61, 132.61, 132.22, 134.90, 137.18, 140.37, 150.48 (ring Cs).

HRMS (EI): Calc: 212.1565. Found: 212.1567.

### (ii) Synthesis of EBI*Na₂

Na (0.17 g, 7.56×10⁻³ mol) was stirred in THF with naphthalene (1.04 g, 8.11×10⁻³ mol) for 15 hours, resulting in a deep green solution of C₁₀H₈Na. After cooling to −78° C., a solution in THF of 2,3,4,5,6,7-hexamethyl-1-methylene-indene (1.50 g, 7.06×10⁻³ mol) was added. The mixture was stirred for 2 hours at −78° C. and then allowed to warm to room temperature. Removal of the solvent under vacuum afforded a light brown solid, which was washed with Et₂O and filtered to give a light brown pyrophoric powder. Yield: 1.26 g, 76%.

Characterising Data:

¹H NMR (d₅-pyridine) δ (ppm): 2.49 (s, 12H, Me), 2.55, 2.71, 2.72, 3.13 (all s, 6H, Me), 3.94 (s, 4H, C₂H₄).

¹³C NMR (d₅-pyridine) δ (ppm): 13.59, 16.41, 17.33, 17.46, 18.60, 19.05 (Me), 35.06 (C₂H₄), 97.01, 104.27, 117.68, 118.07, 123.12, 123.17, 123.77, 125.20, 125.79 (ring Cs).

The reaction mechanism for the above reaction is shown in Scheme 2 below.

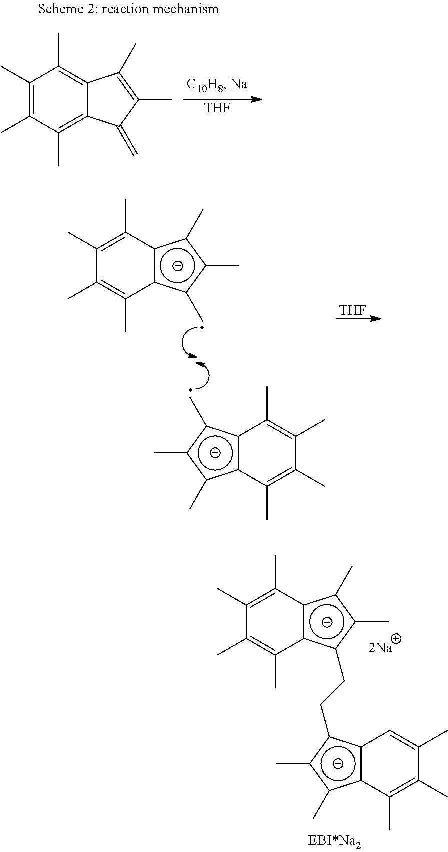

### Preparation of ethylene-bis-hexamethylindenyl zirconium chloride (EBI*ZrCl₂)

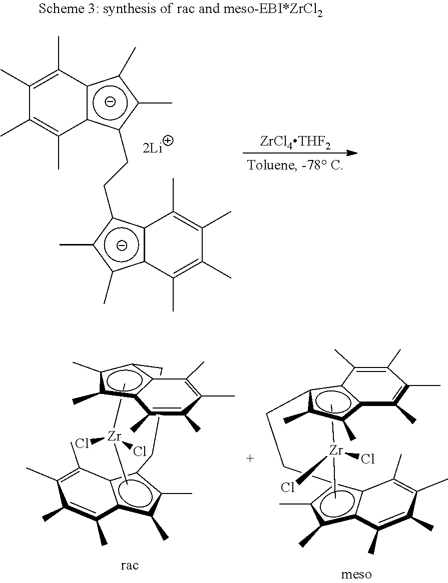

EBI*Li₂.THF_{0.38} (0.350 g, 7.51×10⁻⁴ mol) was slurried in toluene and cooled to −78° C. To this orange-red slurry was added a white slurry of ZrCl₄.THF₂ (0.284 g, 7.51×10⁻⁴ mol) in toluene. No immediate change was observed and the reaction mixture was allowed to warm to room temperature with stirring. After stirring for a further 15 hours, the red-brown reaction mixture was filtered affording a red-orange solution. The residues were extracted with CH₂Cl₂ and the extracts combined. Removal of the solvent under vacuum gave a red-orange solid, which was washed with −78° C. hexane. The resultant residue was extracted with room temperature hexane to give a red-orange solid and yellow-orange solution. NMR analysis of this solid showed it to be an approximately 1:0.8 rac/meso mix. The solvent was removed under vacuum from the yellow-orange solution to give an orange solid; NMR analysis of this solid indicated it to be mainly composed of meso-EBI*ZrCl₂ with a tiny proportion of impurities including the rac-isomer.

The rac/meso mix was extracted and filtered with CH₂Cl₂ to afford a red solution which was layered with hexane. The yellow supernatant was decanted via cannula leaving an orange solid, shown by NMR analysis to be pure rac-EBI*ZrCl₂. The supernatant was reduced under vacuum to an orange solid; a more meso enriched mixture of isomers; and washed with 60° C. hexane, leaving pure rac isomer. The orange-yellow solution was again reduced to an isomeric solid mix, extracted with 60° C. hexane and cooled to −80° C., depositing a final crop of rac-EBI*ZrCl₂. Crystals of rac-EBI*ZrCl₂ suitable for X-ray diffraction were grown as pale orange plates by layering a CD₂Cl₂ solution of the sample with Et₂O.

The predominantly meso extracts were further extracted with 60° C. hexane and filtered, reduced to a minimum volume and cooled slowly to −35° C. Orange needles of pure meso-EBI*ZrCl₂ suitable for X-ray diffraction were collected and washed with −78° C. hexane.

Yield: 0.060 g, 0.028 g, total 20%.

Characterising Data:

HRMS (EI): Calc: 584.1554. Found: 584.1567.

rac-EBI*ZrCl₂:

¹H NMR (C₆D₆) δ (ppm): 1.78, 2.11, 2.22, 2.43, 2.46, 2.56 (all s, 6H, Me), 3.22-3.40, 3.70-3.88 (m, 4H, C₂H₄).

¹H NMR (CDCl₃) δ (ppm): 1.84, 2.23, 2.29, 2.33, 2.40, 2.79 (all s, 6H, Me), 3.65-3.81, 4.02-4.18 (m, 4H, C₂H₄).

¹H NMR (CD₂Cl₂) δ (ppm): 1.84, 2.24, 2.29, 2.31, 2.37, 2.80 (all s, 6H, Me), 4.03-4.22, 3.63-3.82 (m, 4H, C₂H₄).

¹³C NMR (CD₂Cl₂) δ (ppm): 11.96, 15.91, 16.58, 16.91, 17.71, 17.95 (Me), 32.94 (C₂H₄), 115.97, 118.84, 123.56, 125.21, 126.40, 128.84, 129.46, 130.65, 134.59 (ring Cs).

Anal. Calc for C₃₂H₄₀ZrCl₂: C, 65.50; H, 6.87. Found: C, 65.44; H, 6.79.

meso-EBI*ZrCl₂:

¹H NMR (C₆D₆) δ (ppm): 1.85, 1.99, 2.01, 2.39, 2.51, 2.52 (all s, 6H, Me), 3.20-3.34 3.74-3.88 (m, 4H, C₂H₄).

¹H NMR (CDCl₃) δ (ppm): 2.12, 2.13, 2.16, 2.32, 2.45, 2.60 (all s, 6H, Me), 3.63-3.80, 4.07-4.24 (m, 4H, C₂H₄).

¹H NMR (CD₂Cl₂) δ (ppm): 2.13 (s, 12H, Me), 2.17, 2.29, 2.43, 2.61 (all s, 6H, Me), 3.64-3.82, 4.08-4.26 (m, 4H, C₂H₄).

¹³C NMR (C₆D₆) δ (ppm): 13.27, 15.71, 16.51, 16.87, 17.59, 17.71 (Me), 31.39 (C₂H₄), 106.72, 113.97, 121.50, 126.97, 127.29, 129.03, 130.68, 132.98, 134.05 (ring Cs).

¹³C NMR (CDCl₃) δ (ppm): 13.45, 15.41, 16.45, 16.82, 17.40, 17.43 (Me), 31.34 (C₂H₄), 104.09, 114.17, 121.62, 126.25, 126.75, 129.52, 130.21, 133.03, 134.29 (ring Cs).

Structural Analysis of rac-EBI*ZrCl₂

As stated above, single crystals of rac-EBI*ZrCl₂ suitable for X-ray diffraction were grown as pale orange plates by the layering of a sample in CD₂Cl₂ with Et₂O. The compound crystallises in the monoclinic space group C2/c, and four alternate views are shown in FIG. 1. The compound is located on a crystallographic twofold axis of rotation, hence both indenyl rings are equivalent and relevant bond lengths and angles are given in Table 1 below.

TABLE 1
Selected bond lengths and angles for rac-EBI*ZrCl₂. Estimated
standard deviations (ESDs) are given in parentheses
Lengths (Å)

| | | | |
|---|---|---|---|
| Zr(1)—C(3) | 2.479(3) | C(4)—C(14) | 1.439(4) |
| Zr(1)—C(4) | 2.558(3) | C(5)—C(10) | 1.430(4) |
| Zr(1)—C(5) | 2.612(3) | C(10)—C(12) | 1.385(4) |
| Zr(1)—C(6) | 2.582(3) | C(12)—C(13) | 1.432(4) |
| Zr(1)—C(7) | 2.520(3) | C(13)—C(14) | 1.382(4) |
| C(3)—C(4) | 1.448(4) | C(3)—C(18) | 1.504(4) |
| C(4)—C(5) | 1.443(4) | C(18)—C(18)* | 1.546(6) |
| C(5)—C(6) | 1.437(4) | Avg. C₅—Me | 1.505 |
| C(6)—C(7) | 1.414(4) | Avg. C₆—Me | 1.514 |
| C(7)—C(3) | 1.430(4) | Zr(1)—Cp_{cent} | 2.240 |
| | | Zr(1)—Cl(2) | 2.4358(7) |
| | | Δ_{M-C} | 0.054 |

Angles (°)

| | | | |
|---|---|---|---|
| C₆—C₅ planes | 2.6 | δ | 129.4 |
| Cl(2)—Zr—Cl(2)* | 96.24(4) | Hinge Angle | 2.7 |
| α α′ | 57.2 55.6 | Rotation Angle | 124.4 |
| β β′ | −1.1 0.3 | | |

Structural Analysis of meso-EBI*ZrCl₂

As stated above, X-ray quality crystals of meso-EBI*ZrCl₂ were obtained as orange needles by the slow cooling of a concentrated hexane solution to −35° C. The compound crystallises in the triclinic space group P1̅, with one EBI* moiety and one toluene molecule per asymmetric unit. Alternate views are shown in FIG. 2, and relevant bond distances and angles are given in Table 2.

TABLE 2
Selected bond lengths and angles for meso-EBI*ZrCl₂. Estimated
standard deviations (ESDs) are given in parentheses
Lengths (Å)

| | | | |
|---|---|---|---|
| Zr(1)—C(13) | 2.470(5) | Zr(1)—C(4) | 2.627(5) |
| Zr(1)—C(14) | 2.557(5) | Zr(1)—C(5) | 2.596(5) |
| Zr(1)—C(15) | 2.574(5) | Zr(1)—C(6) | 2.487(5) |
| Zr(1)—C(16) | 2.597(5) | Zr(1)—C(7) | 2.504(5) |
| Zr(1)—C(17) | 2.556(5) | Zr(1)—C(8) | 2.570(5) |
| C(13)—C(14) | 1.442(8) | C(4)—C(5) | 1.441(7) |
| C(14)—C(15) | 1.438(8) | C(5)—C(6) | 1.448(8) |
| C(15)—C(16) | 1.436(8) | C(6)—C(7) | 1.422(8) |
| C(16)—C(17) | 1.402(8) | C(7)—C(8) | 1.412(8) |
| C(17)—C(13) | 1.417(8) | C(8)—C(4) | 1.441(7) |
| C(15)—C(20) | 1.435(8) | C(5)—C(28) | 1.429(8) |
| C(20)—C(22) | 1.384(9) | C(28)—C(29) | 1.373(9) |
| C(22)—C(23) | 1.422(10) | C(29)—C(31) | 1.422(9) |
| C(23)—C(24) | 1.369(9) | C(31)—C(32) | 1.379(8) |
| C(24)—C(14) | 1.424(8) | C(32)—C(4) | 1.434(8) |
| C(13)—C(12) | 1.521(8) | C(6)—C(11) | 1.501(8) |
| C(12)—C(11) | 1.539(9) | — | |
| Avg. C₅—Me | 1.512 | Avg. C₅—Me | 1.508 |
| Avg. C₆—Me | 1.513 | Avg. C₆—Me | 1.513 |
| Zr(1)—Cp_{cent} | 2.244 | Hf(1)—Cp_{cent} | 2.248 |
| Zr(1)—Cl(2) | 2.4276(13) | Zr(1)—Cl(3) | 2.4571(14) |
| Δ_{M-C} | 0.033 | Δ_{M-C} | 0.082 |

Angles (°)

| | | | |
|---|---|---|---|
| C₆—C₅ planes | 6.4 | C₆—C₅ planes | 3.9 |
| Cl(2)—Zr—Cl(3) | 97.41(5) | — | |
| α α′ | 56.9 54.4 | — | |
| β β′ | 1.3 2.9 | β β′ | 1.0 1.9 |
| δ | 128.73 | — | |
| Hinge Angle | 6.0 | Hinge Angle | 3.3 |
| Rotation Angle | 46.8 | — | |

### Preparation of ethylene-bis-hexamethylindenyl benzyl zirconium (EBI*Zr(CH₂C₆H₅)₂)

400 mg meso-(EBI*)ZrCl2 (685 μmol) was added to a Schlenk tube along with 223 mg KBz (1.72 mmol) and 30 ml benzene. The mixture was stirred under nitrogen for 48 hours and reduced in vacuo. The product was extracted in hexane as a yellow solid. Yield: 205 mg.

meso-(EBI*)ZrBz₂ was characterised by single crystal X-ray crystallography. Suitable single crystals were grown from hexane and found to crystallise in P 2₁/n. The solid state molecular structure in depicted in FIG. 9.

meso-(EBI*)ZrBz₂ was further characterised by ¹H NMR spectroscopy and mass spectrometry as follows: ¹H NMR (400 MHz, C₆D₆): δ −0.70 (s, 2H, PhCH₂), 1.83 (s, 2H, PhCH₂), 1.85 (s, 6H, Cp-Me), 2.01 (s, 6H, Ar-Me), 2.04 (s, 12H, Ar-Me), 2.41 (s, 6H, Ar-Me), 2.50 (s, 6H, Ar-Me), 3.07 (m, 3.02-3.13, 2H, CH₂), 3.67 (m, 3.62-3.73, 2H, CH₂), 6.39 (d, J=7.5 Hz, 2H, o-Ph), 6.58 (d, J=7.5 Hz, 2H, o-Ph), 6.80 (t, J=7.2 Hz, 1H, p-Ph), 6.95 (t, J=7.3 Hz, 1H, p-Ph), 7.04 (t, J=7.6 Hz, 2H, m-Ph), 7.16 (t, J=7.6 Hz, 2H, m-Ph).

MS (EI): found 726.2760. calculated 726.3198. Major fragmentation peaks noted at 635, 544 and 91 corresponding to EBI*ZrBz⁺, EBI*Zr⁺ and Bz⁺ respectively.

Preparation of (Ind^{#}₂ZrCl₂)

4 g Ind^{#}Li (19.4 mmol) was added to a Schlenk tube along with 2.23 g ZrCl₄ (9.71 mmol) and 100 ml benzene. The mixture was stirred under nitrogen for 72 hours and filtered. The product was collected as an orange solid as a mixture of rac- and meso-isomers. Yield: 205 mg.

Both isomers, rac- and meso-Ind^{#}ZrCl₂ were characterised by X-ray crystallography. In each case, crystals were grown from hexane and were found to crystallise in P 2₁/c and P 2₁/n respectively. The solid state molecular structures are depicted in FIGS. 10 and 11.

In addition, both isomers were characterised by ¹H and ¹³C NMR spectroscopy and elemental analysis as follows:

rac-Ind^{#}₂ZrCl₂

¹H NMR (400 MHz, CDCl₃): δ 1.60 (s, 6H, Cp-Me), 2.25 (s, 6H, Ar-Me), 2.26 (s, 6H, Ar-Me), 2.43 (s, 6H, Ar-Me), 2.54 (s, 6H, Ar-Me), 2.60 (s, 6H, Cp-Me), 6.26 (s, 1H, Cp-H).

¹H NMR (400 MHz, C₆D₆): δ 1.55 (s, 6H, Cp-Me), 2.08 (s, 6H, Ar-Me), 2.15 (s, 6H, Ar-Me), 2.39 (s, 6H, Ar-Me), 2.49 (s, 6H, Ar-Me), 2.57 (s, 6H, Cp-Me), 6.12 (s, 1H, Cp-H).

CHN Analysis (%). Expected: C, 64.50, H, 6.86. Found: C, 64.35, 6.74.

meso-Ind^{#}₂ZrCl₂

¹H NMR (400 MHz, CDCl₃): δ 2.13 (s, 6H, Cp-Me), 2.18 (s, 6H, Ar-Me), 2.19 (s, 6H, Ar-Me), 2.23 (s, 6H, Ar-Me), 2.51 (s, 6H, Cp-Me), 2.52 (s, 6H, Ar-Me), 5.83 (s, 1H, Cp-H).

¹H NMR (400 MHz, C₆D₆): δ 2.00 (s, 6H, Cp-Me), 2.02 (s, 6H, Ar-Me), 2.05 (s, 6H, Ar-Me), 2.06 (s, 6H, Ar-Me), 2.54 (s, 6H, Ar-Me), 2.55 (s, 6H, Cp-Me), 5.60 (s, 1H, Cp-H).

CHN Analysis (%). Expected: C, 64.50, H, 6.86. Found: C, 64.37, 6.81.

### Preparation of ethylene-bis-hexamethylindenyl neopentyl chloride zirconium (EBI*Zr(CH₂C(CH₃)₃Cl)

200 mg meso-(EBI*)ZrCl2 (343 μmol) was added to a Schlenk tube along with 26.8 mg LiNp (343 μmol) and 30 ml benzene. The mixture was stirred under nitrogen for 48 hours and reduced in vacuo. The product was extracted in hexane as a yellow solid. Yield: 34 mg.

meso-(EBI*Zr(CH₂C(CH₃)₃)Cl) was characterised by single crystal X-ray crystallography. Suitable single crystals were grown from hexane and found to crystallise in P1̅. The solid state molecular structure in depicted in FIG. 12.

meso-(EBI*)ZrBz₂ was further characterised by ¹H and ¹³C NMR spectroscopy as follows:

¹H NMR (400 MHz, C₆D₆): δ −2.23 (s, 2H, CH₂^{t}Bu), 0.74 (s, 9H, CMe₃), 1.92 (s, 6H, Cp-Me), 2.07 (s, 6H, Ar-Me), 2.14 (s, 6H, Ar-Me), 2.44 (s, 6H, Ar-Me), 2.47 (s, 6H, Ar-Me), 2.53 (s, 6H, Ar-Me), 3.16 (m, 3.10-3.25, 2H, CH₂), 3.63 (m, 3.56-3.69, 2H, CH₂).

¹³C {¹H} NMR (400 MHz, C₆D₆): δ 14.06 (Ar-Me), 16.30 (Ar-Me), 16.77 (Ar-Me), 16.86 (Ar-Me), 17.71 (Ar-Me), 18.81 (Ar-Me), 30.86 (CH₂), 34.95 (CMe₃), 77.24 (CH₂^{t}Bu) 111.79 (Cp), 116.90 (Cp), 125.22 (Ar), 127.53 (Ar), 127.95 (Ar), 129.50 (Cp), 130.27 (Ar), 132.47 (Ar), 133.72 (Ar). Preparation of rac-Ind^{#}₂ZrBz₂

400 mg Ind^{#}₂ZrCl₂ (0.717 mmol) was added to a schlenk with 233 mg KBz (1.79 mmol) and 30 ml benzene. The mixture was stirred under nitrogen for 24 hours, dried in vacuo and the product extracted as the meso-isomer in hexane as a yellow solid. Yield: 83 mg.
rac-Ind^{#}₂ZrBz₂ was characterised by single crystal X-ray diffraction. Suitable crystals were grown from toluene and were found to crystallise in P 2₁/n. The solid state molecular structure is shown in FIG. 13.

### Synthesis of Supported Catalyst Systems

### Synthesis of Solid MAO/(EBI*)ZrCl₂ Catalyst System (Example 1)

Toluene (40 ml) was added to a Schlenk tube containing solid Tosoh supplied solid MAO (TOSOH Lot no. TY130408), (331 mg) and (EBI*)ZrCl₂ (14.3 mg) at room temperature. The slurry was heated to 60° C. and left, with occasional swirling, for one hour during which time the solution turned colourless and the solid colourised purple. The resulting suspension was then left to cool down to room temperature and the toluene solvent was carefully filtered and removed in vacuo to obtain Solid MAO/EBI*ZrCl₂ catalyst as a pale purple, free-flowing powder. Yield: 313 mg.

### Synthesis of SSMAO/[(EBI*)ZrCl₂ Catalyst System (Comparative Example)

Toluene (40 ml) was added to a Schlenk tube containing MAO activated silica (SSMAO), (528 mg) and (EBI*)ZrCl₂ (5.8 mg) at room temperature. The slurry was heated to 60° C. and left, with occasional swirling, for one hour during which time the solution turned colourless and the solid colourised purple. The resulting suspension was then left to cool down to room temperature and the toluene solvent was carefully filtered and removed in vacuo to obtain SSMAO/EBI*ZrCl₂ catalyst as a pale purple, free-flowing powder. Yield: 471 mg.

### Ethylene Polymerisation Studies

### Homopolymerisation of Ethylene

Solid MAO/[Zr-Complex] catalysts (Zr-Complex=rac-[(EBI*)ZrCl₂], meso[(EBI*)ZrCl₂] and meso-[(EBI*)ZrBz₂] were tested for their ethylene polymerisation activity under slurry conditions in the presence of tri(isobutyl)aluminium (TIBA), an aluminium-based scavenger. The reactions were performed under 2 bar of ethylene in a 200 mL ampoule, with 10 mg of the catalyst suspended in 50 mL of hexane. The reactions were run for 30 minutes at a temperature controlled by heating in an oil bath. The resulting polyethylene was immediately filtered under vacuum through a dry sintered glass frit. The polyethylene product was then washed with pentane (2×25 ml) and then dried on the frit for at least one hour. The tests were carried out at least twice for each individual set of polymerisation conditions.

FIG. 3 shows ethylene polymerisation activity for rac-[(EBI*)ZrCl₂], meso-[(EBI*)ZrCl₂] and meso-[(EBI*)ZrBz₂] metallocenes supported on Tosoh Finechem solid MAO. For reference, FIG. 3 also shows the polymerisation activity for [(Ind*)₂ZrCl₂] supported on Tosoh Finechem solid MAO, in which the ethylene bridge is absent. Polymerisation conditions: 2 bar ethylene, 30 minutes, 50 ml hexane, 10 mg catalyst, 150 mg TIBA, 300:1 Al:Zr support loading on solid MAO.

FIG. 4 shows ethylene polymerisation activity with varying temperature for [rac(EBI*)ZrCl₂] metallocene supported on Tosoh Finechem solid MAO. Polymerisation conditions: 2 bar ethylene, 30 minutes, 50 ml hexane, 10 mg catalyst, 150 mg TIBA, 200:1 Al:Zr support loading on Tosoh Finechem solid MAO (TOSOH Lot no. TY130408). The data show that the solid MAO/[(EBI*)ZrCl₂] catalyst system exhibits a high degree of polymerisation activity across a broad range of temperatures (notably 30-70° C.)

Table 3 below provides a comparison of ethylene polymerisation activity at various temperatures for [rac-(EBI*)ZrCl₂] when supported on Tosoh Finechem solid MAO (Example 1) and a conventional MAO-activated silica support (comparative example). Polymerisation conditions: zirconocene catalyst=rac-(EBI*)ZrCl₂, 2 bar ethylene, 30 minutes, 50 ml hexane, 10 mg catalyst, 150 mg TIBA, 300:1 Al:Zr for MAO Activated Silica and 200:1 for Solid Tosoh MAO.

TABLE 3
Ethylene polymerisation activity for [rac-(EBI*)ZrCl₂]
when supported on Tosoh Finechem solid MAO and
a conventional MAO-activated silica support.

| | Polymerisation activity (kg_{PE}/mol_{Zr}/h) | | |
|---|---|---|---|
| | MAO | Solid | |
| Temperature | Activated | Tosoh | Increase in |
| (° C.) | Silica | MAO | activity |
| 30 | — | 7540 | — |
| 40 | — | 9601 | — |
| 50 | 3300 | 9641 | 2.92 |
| 60 | 4302 | 10012 | 2.33 |
| 70 | 3879 | 9074 | 2.34 |
| 80 | 3157 | 6096 | 1.93 |
| 90 | 1554 | 4812 | 3.10 |

Having regard to the data presented in Table 3 above, it is clear that the compositions of the present invention are markedly more active in ethylene polymerisation than analogous silica-supported metallocenes.

FIG. 5 provides a comparison of the molecular weight of polyethylene produced by polymerisation reactions using rac-[(EBI*)ZrCl₂], meso-[(EBI*)ZrCl₂] and meso-[(EBI*)ZrBz₂] metallocenes supported on Tosoh Finechem solid MAO. FIG. 5 also shows data for [(Ind^{#})₂ZrCl₂] supported on Tosoh Finechem solid MAO, in which the ethylene bridge is absent. The data show that the polyethylene produced by polymerisation reactions using the compositions of the present invention has a high molecular weight. High molecular weight polyethylenes are highly valued by industry. Polymerisation conditions: 2 bar ethylene, 30 minutes, 50 ml hexane, 10 mg catalyst, 150 mg TIBA, 300:1 Al:Zr support loading on solid MAO.

FIG. 6 shows the variation in the molecular weight of polyethylene produced by polymerisation reaction at various temperatures using [rac-(EBI*)ZrCl₂] metallocene supported on Tosoh Finechem solid MAO (TOSOH Lot no. TY130408). The data show that polyethylene produced by polymerisation reactions using solid MAO/[(EBI*)ZrCl₂] catalyst system exhibits high molecular weight across a broad range of reaction temperatures (30 90° C.). Polymerisation conditions: 2 bar ethylene, 30 minutes, 50 ml hexane, 10 mg catalyst, 150 mg TIBA, 200:1 Al:Zr support loading on Tosoh Finechem solid MAO.

FIG. 7 provides a comparison of the polydispersity of polyethylene produced by polymerisation reactions using rac-[(EBI*)ZrCl₂], meso-[(EBI*)ZrCl₂] and meso-[(EBI*)ZrBz₂] metallocenes supported on Tosoh Finechem solid MAO. FIG. 7 also shows data for [(Ind^{#})₂ZrCl2] supported on Tosoh Finechem solid MAO, in which the ethylene bridge is absent. The data show that polyethylene produced by polymerisation reactions using the compositions of the present invention has a low polydispersity index, indicating a high degree of uniformity amongst the polymeric molecules. Low polydispersity polyethylenes are highly valued by industry. Polymerisation conditions: 2 bar ethylene, 30 minutes, 50 ml hexane, 10 mg catalyst, 150 mg TIBA, 300:1 Al:Zr support loading on solid MAO.

FIG. 8 shows the variation in the polydispersity of polyethylene produced by polymerisation reaction at various temperatures using [rac-(EBI*)ZrCl₂] metallocene supported on Tosoh Finechem solid MAO. The data show that polyethylene produced by polymerisation reactions using solid MAO/[(EBI*)ZrCl₂] catalyst system exhibits a very low polydispersity index across a broad range of reaction temperatures (40-90° C.). Polymerisation conditions: 2 bar ethylene, 30 minutes, 50 ml hexane, 10 mg catalyst, 150 mg TIBA, 200:1 Al:Zr support loading on Tosoh Finechem solid MAO (TOSOH Lot no. TY130408).

FIG. 14 shows the activity data for rac-EBI*ZrCl₂ on SSMAO and Solid MAO demonstrating that the Solid MAO supported catalyst is vastly superior to that for the complex supported on SSMAO; the activity at all temperatures is double or greater.

FIG. 15 and Table 4 show that rac-EBI*ZrCl₂ is faster than meso-EBI*ZrCl₂ when the catalysts were supported on Solid MAO, the differential is 3.5 at 80° C. and 4 at 50° C. It is perhaps interesting to note that while meso-EBI*ZrCl₂ shows an optimum activity at 70° C. (2,246 kg_{PE}/mol_{Zr}/h/bar), rac-EBI*ZrCl₂ peaks at only 50° C. (5,365 kg_{PE}/mol_{Zr}/h/bar).

TABLE 4
Ethylene polymerisation activity for rac-(EBI*)ZrCl₂ and meso-
EBI*ZrCl₂ when supported on Tosoh Finechem solid MAO.

| T | Activity for rac-(EBI*)ZrCl₂ | Activity for meso-(EBI*)ZrCl₂ |
|---|---|---|
| (° C.) | (kg_{PE}/mol_{Zr}/h/bar) | (kg_{PE}/mol_{Zr}/h/bar) |
| 30 | 3770 ± 254 | |
| 40 | 4267 ± 35 | |
| 50 | 5365 ± 145 | 1347 ± 68 |
| 60 | 5006 ± 105 | 1331 ± 72 |
| 70 | 4537 ± 440 | 2246 ± 271 |
| 80 | 3048 ± 378 | 877 ± 164 |
| 90 | 2406 ± 30 | 513 ± 40 |

FIG. 16 and Table 5 show that both meso-(EBI*)ZrBz₂ and meso-(EBI*)ZrNpCl show optimum activities higher than the 2,246 kg_{PE}/mol_{Zr}/h/bar for meso-EBI*ZrCl₂ (5,179 and 2,436 kg_{PE}/mol_{Zr}/h/bar respectively). While the neopentyl chloride only marginally outperforms the dichloride congener, and at a lower, less commercially suitable temperature, the peak performance of the benzyl is more than twice that of the others.

TABLE 5
Ethylene polymerisation activity (kg_{PE}/mol_{Zr}/h/bar)
and M_{w} (kg/mol) for meso-(EBI*)ZrBz₂ and meso-(EBI*)ZrNpCl
when supported on Tosoh Finechem solid MAO.

| | Activity for | M_{w} for | Activity for | M_{w} for |
|---|---|---|---|---|
| T | meso- | meso- | meso- | meso- |
| (° C.) | (EBI*)ZrBz₂ | (EBI*)ZrBz₂ | (EBI*)ZrNpCl | (EBI*)ZrNpCl |
| 40 | | | 1886 ± 86 | 283664 |
| 50 | 4845 ± 28 | 134584 | 2436 ± 92 | 241591 |
| 60 | 5179 ± 294 | 176708 | 1922 ± 33 | 267834 |
| 70 | 2501 ± 13 | 136926 | 1659 ± 7 | 250833 |
| 80 | 2976 ± 188 | 132919 | 1215 ± 178 | 201683 |
| 90 | 2252 ± 254 | 132444 | 898 ± 90 | 187530 |

FIG. 18 and Table 6 compare the activities of the dichloride compounds as pure rac-, pure meso- and a 50:50 mix of the two. Most surprisingly of all the isomeric mixture of Ind₂^{#}ZrCl₂ gave rise to higher activities than either of the single isomers on their own (1,152 kg_{PE}/mol_{Zr}/h/bar at 70° C.). It is difficult to be sure of what causes this phenomenon, but it is suspected that some cooperative effect between the two catalytic sites must be at work with a chain-shuttling process in operation.

TABLE 6
Ethylene polymerisation activity (kg_{PE}/mol_{Zr}/h/bar) for
rac-, meso-, mixed-Ind₂^{#}ZrCl₂ and rac- Ind₂^{#}ZrBz₂
on temperature when supported on Tosoh Finechem solid MAO.

| | Activity for | Activity for | Activity for | Activity for |
|---|---|---|---|---|
| T | mixed- | rac- | meso- | rac- |
| (° C.) | Ind₂^{#}ZrCl₂ | Ind₂^{#}ZrCl₂ | Ind₂^{#}ZrCl₂ | Ind₂^{#}ZrBz₂ |
| 30 | | | | 871 ± 38 |
| 40 | | | | 1146 ± 111 |
| 50 | 1108 ± 13 | 840 ± 6 | 336 ± 47 | 1538 ± 114 |
| 60 | 1073 ± 28 | 870 ± 2 | 343 ± 7 | 1063 ± 39 |
| 70 | 1152 ± 128 | 744 ± 26 | 442 ± 57 | 777 ± 1 |
| 80 | 614 ± 72 | 535 ± 46 | 303 ± 38 | 510 ± 73 |
| 90 | 346 ± 64 | 359 ± 79 | 214 ± 15 | 273 ± 36 |

While specific embodiments of the invention have been described herein for the purpose of reference and illustration, various modifications will be apparent to a person skilled in the art without departing from the scope of the invention as defined by the appended claims.

### REFERENCES

1 J. Cosier, A. M. Glazer, J. Appl. Cryst. 19 (1986) 105
2 Z. Otwinowski, W. Minor, Methods Enzymol. 276 (1997) 307
3 L. Palatinus, G. Chapuis, J. Appl. Cryst. 40 (2007) 786
4 P. W. Betteridge, J. R. Carruthers, R. I. Cooper, K. Prout, D. J. Watkin, J. Appl. Cryst. 36 (2003) 1487
5 R. I. Cooper, A. L. Thompson, D. J. Watkin, J. Appl. Cryst. 43 (2010) 1100

1. A composition comprising a solid methyl aluminoxane support material and compound of the formula (I) shown below: 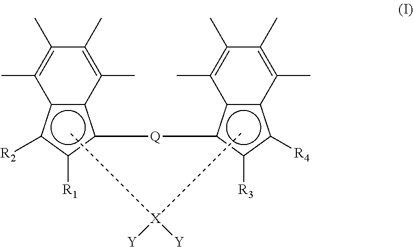
wherein
R₁, R₂, R₃ and R₄ are each independently (1-3C)alkyl;
Q is absent, or is a bridging group comprising 1, 2 or 3 bridging carbon atoms, and is optionally substituted with one or more groups selected from the group consisting of hydroxyl, (1-6C)alkyl, (2-6C)alkenyl, (2-6C)alkynyl, (1-6C)alkoxy, Si[(1-4C)alkyl]₃, aryl, and —C(O)NRₓR_{y};
X is selected from zirconium, titanium or hafnium; and
each Y group is independently selected from the group consisting of halo, hydrogen, a phosphonate anion, a sulfonate anion, a borate anion, (1-6C)alkyl, (2-6C)alkenyl, (2-6C)alkynyl, (1-6C)alkoxy, aryl and aryloxy, wherein each of (1-6C)alkyl, (2-6C)alkenyl, (2-6C)alkynyl, (1-6C)alkoxy, aryl, and aryloxy is optionally substituted with one or more groups selected from the group consisting of (1-6C)alkyl, halo, nitro, amino, phenyl, (1-6C)alkoxy, Si[(1-4C)alkyl]₃ and —C(O)NRₓR_{y};
wherein Rₓ and R_{y} are independently (1-4C)alkyl.

2. The composition according to claim 1, wherein R₁, R₂, R₃ and R₄ are each independently (1-2C)alkyl.

3. The composition according to claim 2, wherein R₁, R₂, R₃ and R₄ are all methyl.

4. The composition according to claim 1, wherein Q is absent, or is a bridging group having the formula —[C(Rₐ)(R_{b})—C(R_{c})(R_{d})]—, wherein Rₐ, R_{b}, R_{c} and R_{d} are independently selected from the group consisting of hydrogen, hydroxyl, (1-4C)alkyl, (2-4C)alkenyl, (2-4C)alkynyl and phenyl.

5. The composition according to claim 4, wherein Q is absent, or is a bridging group having the formula —CH₂CH₂—.

6. The composition according to claim 1, wherein each Y is independently selected from the group consisting of halo, —CH₂C(CH₃)₃ and (1-2C)alkyl which is optionally substituted with halo or phenyl.

7. The composition according to claim 6, wherein each Y is independently selected from the group consisting of Cl, —CH₂C(CH₃)₃ and —CH₂C₆H₅.

8. The composition according to claim 1, wherein X is zirconium or hafnium.

9. The composition according to claim 1, wherein the compound of formula (I) has the formula (III): 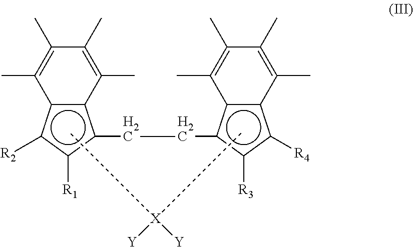
wherein:
R₁, R₂, R₃ and R₄ are each independently (1-3C)alkyl;
X is selected from zirconium, titanium or hafnium; and
each Y group is independently selected from the group consisting of halo, hydrogen, a phosphonate anion, a sulfonate anion, a borate anion, (1-6C)alkyl, (2-6C)alkenyl, (2-6C)alkynyl, (1-6C)alkoxy, aryl and aryloxy, wherein each of (1-6C)alkyl, (2-6C)alkenyl, (2-6C)alkynyl, (1-6C)alkoxy, aryl, and aryloxy is optionally substituted with one or more groups selected from the group consisting of (1-6C)alkyl, halo, nitro, amino, phenyl, (1-6C)alkoxy, Si[(1-4C)alkyl]₃ and —C(O)NRₓR_{y},
wherein Rₓ and R_{y} are independently (1-4C)alkyl.

10. The composition according to claim 1, wherein the composition further comprises at least one suitable activator

11. The composition according to claim 10, wherein the activator is an alkyl aluminium compound.

12. The composition according to claim 11, wherein the activator is methylaluminoxane (MAO), triisobutylaluminium (TIBA), diethylaluminium (DEAC) or triethylaluminium (TEA).

13. A process for forming a polyolefin comprising contacting a composition as defined in claim 1 with one or more olefin monomers to provide a homopolymer or a copolymer.

14. The process according to claim 13, wherein the copolymer comprises 1-10 wt % of a (4-8C) α-olefin.

15. (canceled)

16. The process according to claim 14, wherein the process is performed at a temperature of 25-100° C.

17. The process according to claim 14, wherein the process is performed at a temperature of 70-80° C.

18. The composition according to claim 9, wherein R₁, R₂, R₃ and R₄ are all methyl.

19. The composition according to claim 18, wherein each Y is independently selected from Cl, —CH₂C(CH₃)₃ or —CH₂C₆H₅.

20. The composition according to claim 19, wherein X is zirconium or hafnium.

21. The composition according to claim 20, wherein X is zirconium.
